(19) United States
(12) Patent Application Publication
(10) Pub. No.: US 2006/0179011 A1
(43) Pub. Date: Aug. 10, 2006

(54) Methods and apparatus for negotiations

(76) Inventor: Martin E. Latz, Scottsdale, AZ (US)

Correspondence Address: Noblitt & Gilmore, LLC, Suite 6000, 4800 North Scottsdale Road, Scottsdale, AZ, 85251, US

(21) Appl. No.: 11/351,427

(22) Filed: Feb. 9, 2006

Related U.S. Application Data
(60) Provisional application No. 60/651,335, filed on Feb. 9, 2005.

(51) Int. Cl. G06Q 99/00; H04L 9/00; H04K 1/00

(52) U.S. Cl. 705/80; 705/1

(57) ABSTRACT

A negotiation system according to various aspects of the present invention comprises an information system configured to store negotiation information relating to a negotiation, and an assessment system responsive to the negotiation information from the information system for automatically assessing the negotiation according to the negotiation information. The negotiation system stores the negotiation information in a memory, automatically assesses the negotiation information, and provides a negotiation analysis according to the assessment.

### CROSS-REFERENCES TO RELATED APPLICATION

This application claims the benefit of U.S. Provisional Patent Application No. 60/651,335, filed Feb. 9, 2005 and incorporates the disclosure of that application by reference.

### FIELD OF THE INVENTION

The invention relates to methods and apparatus for planning, executing, and tracking negotiations.

### BACKGROUND OF THE INVENTION

Negotiations are a part of many interactions. Most people, however, engage in negotiations based primarily on instinct and experience, without learning the strategies and techniques of effective negotiating. Despite common belief, certain principles govern nearly every negotiation, from multi-million dollar corporate deals to everyday interactions with spouses and friends. Without training and experience, negotiators may not be effective in pursuing their interests, and few tools are available to assist negotiators in preparing, performing, and learning from negotiations.

### SUMMARY OF THE INVENTION

A strategic negotiation system according to various aspects of the present invention comprises an information system configured to capture, organize and store strategic negotiation information relating to a negotiation and an assessment system for processing, planning, and strategically using the negotiation information. The strategic negotiation system captures, stores, and strategically organizes the negotiation information in a memory, assesses the negotiation information, and provides a negotiation analysis and recommendations according to the assessment.

### BRIEF DESCRIPTION OF THE DRAWING FIGURES

A more complete understanding of the present invention may be derived by referring to the detailed description when considered in connection with the following illustrative figures. In the following figures, like reference numbers refer to similar elements and steps.

FIG. 1 is a block diagram of a strategic negotiation system according to various aspects of the present invention;

FIG. 2 is a block diagram of a strategic negotiation system according to various aspects of the present invention;

FIGS. 3A-B are an illustration of a quick start home page interface;

FIGS. 4A-C are illustrations of a contact information interface and a company information interface;

FIG. 5 is a tree diagram illustrating various functions that may be offered by the strategic negotiation system;

FIGS. 6A-B are an illustration of a new strategic negotiation interface;

FIGS. 7A-B are an illustration of a template building interface;

FIG. 8 is an illustration of a strategic negotiation details interface;

FIGS. 9A-C are an illustration of an information-gathering interface;

FIGS. 10A-D are an illustration of a leverage interface;

FIG. 11 is an illustration of a standards interface;

FIG. 12 is an illustration of an offer-concession interface;

FIG. 13 is an illustration of an agenda interface;

FIG. 14 is an illustration of a strategies interface;

FIG. 15 is an illustration of a knowledge base interface;

FIG. 16 is an illustration of user management interface; and

FIG. 17 is a flow chart of a process for the strategic negotiation system.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

The present invention is described partly in terms of functional components and various processing steps. Such functional components and processing steps may be realized by any number of components, operations, and techniques configured to perform the specified functions and achieve the various results. For example, the present invention may employ various elements, materials, computers, networks, databases, storage systems and media, information gathering techniques and processes, strategy criteria, and the like, which may carry out a variety of functions. In addition, although the invention is described in the negotiation context, the present invention may be practiced in conjunction with any number of applications, environments, and decision-making and strategy planning processes; the systems described are merely exemplary applications for the invention.

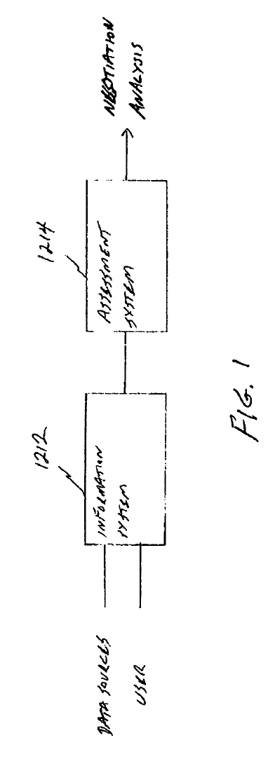

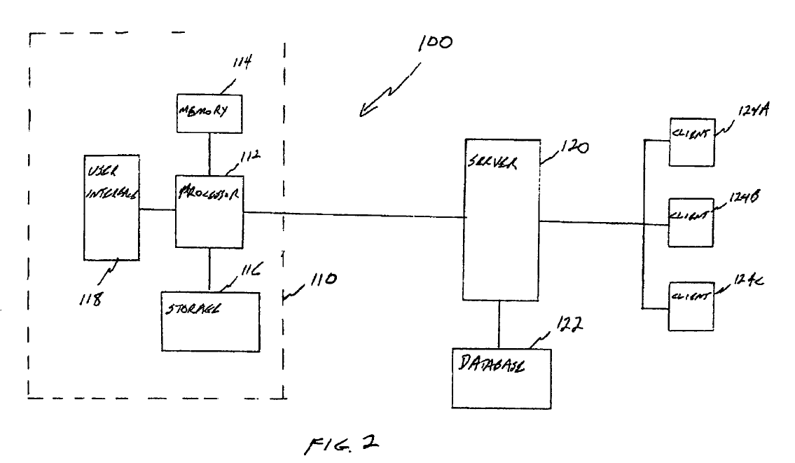

Referring to FIG. 1, a strategic negotiation system 100 according to various aspects of the present invention comprises an information system 1212 and an assessment system 1214. The information system 1212 stores negotiation information relating to a negotiation and the assessment system 1214 processes the negotiation information as stored in the information system 1212 and assesses the negotiation according to the negotiation information. The information system 1212 may receive the negotiation information from any suitable source, such as from one or more users and/or a database. The information system 1212 may be configured to selectively retrieve negotiation information from any suitable source, such as from software programs and databases. The negotiation information may comprise any information relevant to a negotiation, such as details relating to the parties, the subject matter of the negotiation, the potential value of the subject matter to each party, timetables, or other relevant information. The negotiation information may be entered as by a keyboard, selected from a menu of preset options, selected from a menu of previous entries, retrieved from previous negotiations, combinations thereof, or using other systems of data entry or retrieval.

The assessment system 1214 may process the negotiation information according to any suitable algorithm or process and according to any suitable objective. For example, the assessment system 1214 may be configured to automatically evaluate the strategic negotiation information for completeness in various subject areas, attempt to acquire additional information via the information system 1212, and analyze the information according to preselected criteria. The assessment system 1214 may, for example, determine the leverage of the respective parties, recommend techniques for handling certain types of negotiators and/or negotiations, and identify potentially effective negotiation strategies in a variety of different environments and for different individuals. The assessment system 1214 may provide guidance information for use in the negotiation, such as presenting organized, useable negotiation information and or a resulting negotiation analysis, for example by providing an analysis to a user or making the analysis available to multiple parties and/or managers. The assessment system 1214 is distinguishable from the information system 1212 in that the information system 1212 provides for strategic capture, storage, and/or retrieval of data, whereas the assessment system 1214 provides for organizing, presenting, and processing the information. The assessment system 1214 and information system 1212 may be configured for interoperability such as where the information system 1212 provides information for processing by the assessment system 1214 and the information system 1212 further stores the resulting information as processed by the assessment system 1214.

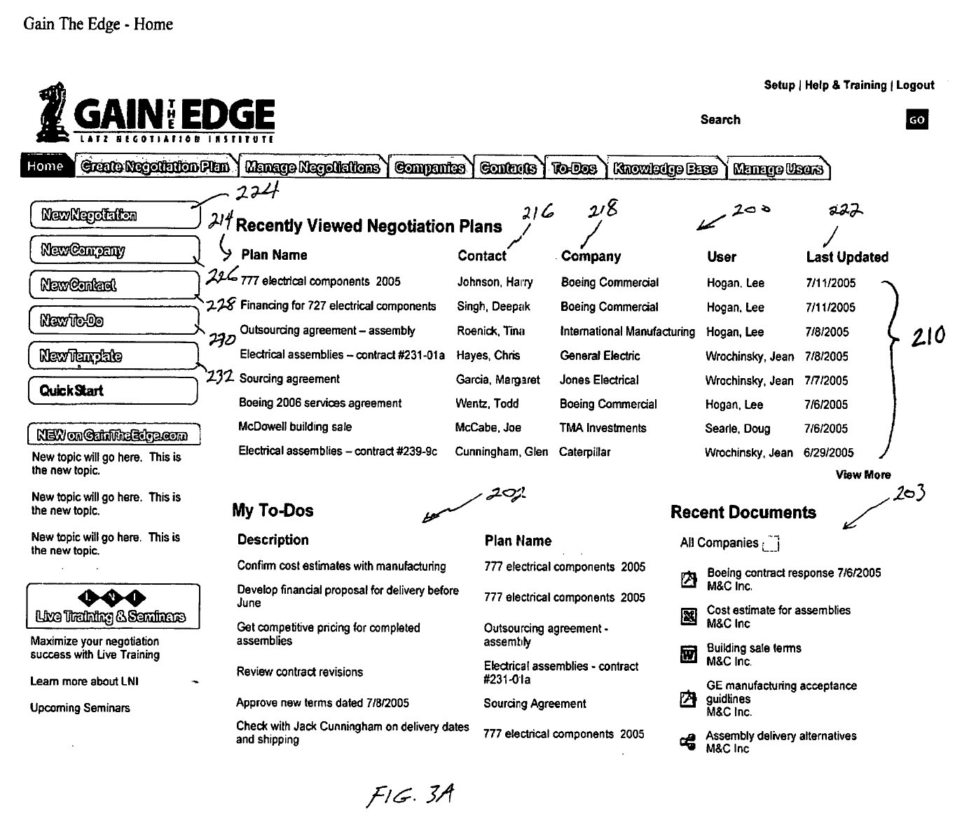

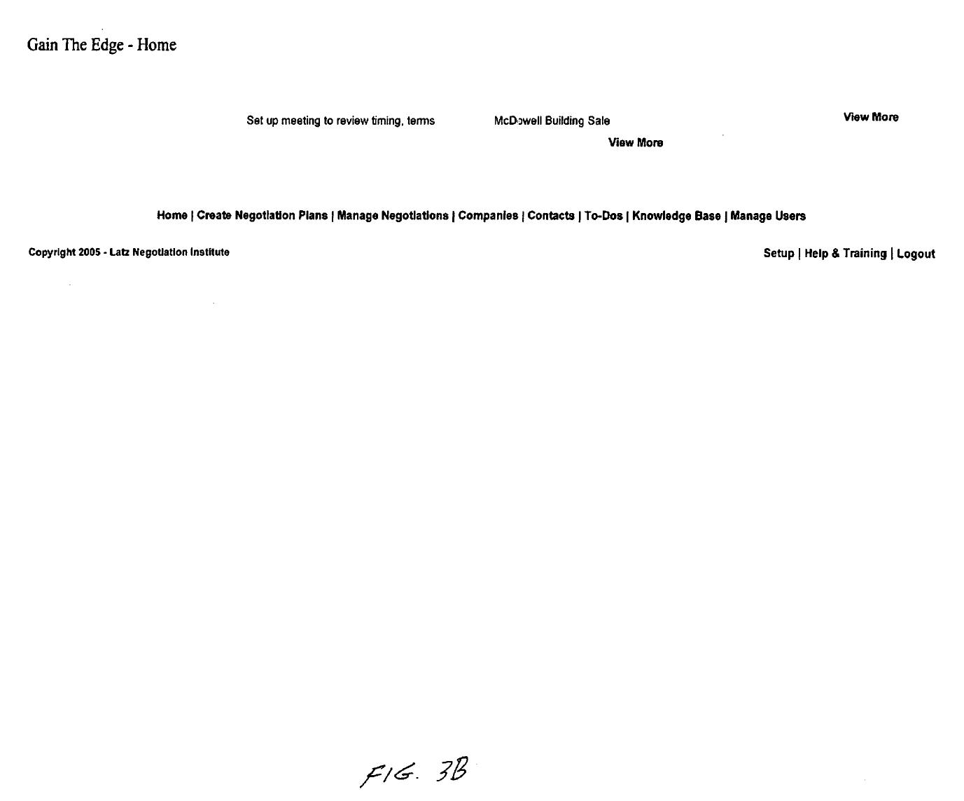

The strategic negotiation system 100 may be implemented in any suitable manner, for example using a computer program operating on a computer system. The computer program may be stored on any suitable medium, such as a hard drive, an optical medium, a tape, a solid-state memory, or other suitable storage medium. Referring to FIG. 2, a strategic negotiation system 100 according to various aspects of the present invention may be implemented in conjunction with a computer system 110, for example a conventional computer system comprising a processor 112 and a random access memory 114, such as a remotely-accessible application server, network server, personal computer, or workstation. The computer system 110 also suitably includes additional memory devices or information storage systems, such as a mass storage system 116, and a user interface 118, for example a conventional monitor, keyboard, and tracking device. The computer system 110 may, however, comprise any suitable computer system and associated equipment, and may be configured in any suitable manner. In one embodiment, the computer system 110 comprises a stand-alone system. In another embodiment, the computer system 110 is part of a network of computers including a server 120 and a database 122. The database stores information that may be made accessible to multiple users 124A-C, such as different users connected to the server 120. In the present embodiment, the server 120 comprises a remotely-accessible server, such as an application server that may be accessed via a network, such as the Internet. Various users may access the server 120, for example by accessing a web page on the worldwide web and logging into or creating a unique user account.

The software required for storing and processing the strategic negotiation information may be implemented in a single device or implemented in a plurality of devices. The software may be accessible via a network such that storage and processing of strategic negotiation information takes place remotely with respect to users 124A-C. The strategic negotiation system 100 according to various aspects of the present invention and its various elements provide functions and operations to facilitate negotiations, such as planning, executing, evaluating, and tracking the progress of negotiations. The present strategic negotiation system 100 maintains information relating to one or more negotiations and facilitates the planning and progress of the negotiation. For example, in the present embodiment, the computer system 110 executes the computer program, which may receive, store, search, analyze, and report information relating to negotiations. The computer program may comprise multiple modules performing various functions or operations, such as an information module for implementing the information system and an assessment module for implementing the assessment system. In the present embodiment, the computer program interacts with the user via a series of graphical user interfaces, and presents fields for collecting strategic information and selections and operations for operating the strategic negotiation system 100.

The procedures performed by the strategic negotiation system 100 may comprise any suitable processes to facilitate negotiations. In the present embodiment, the strategic negotiation system 100 prompts the user for strategic information relating to the negotiation and stores that information. The strategic negotiation system 100 also retrieves information, for example from the database 122, that may assist with or otherwise be relevant to a particular negotiation. In addition, the strategic negotiation system 100 analyzes information to provide guidance in executing the negotiation successfully.

The strategic negotiation system 100 may also provide various additional modules and/or individual functions. For example, the present strategic negotiation system 100 includes various main negotiation functions for facilitating and/or maximizing the effectiveness of the negotiation. The strategic negotiation system 100 also includes and/or accesses a contact and company information database to generate, store, access, and maintain information regarding parties to negotiations. The strategic negotiation system 100 may also provide various administrative and management functions, such as generating to-do lists, preparing offer-concession charts and patterns and strategies, negotiation histories, and counterpart profiles.

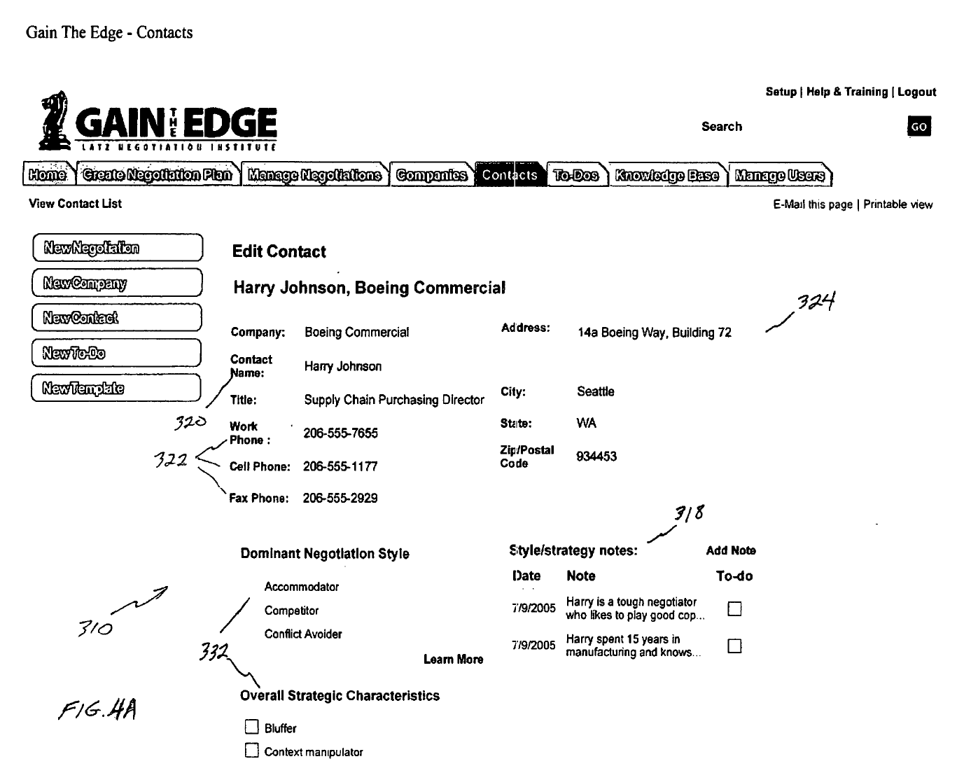

For example, the strategic negotiation system 100 may perform a project list function for organizing and presenting existing negotiation projects. In the present embodiment, referring to FIGS. 3A-B, the strategic negotiation system 100 presents a quick start home page to provide strategic information relating to various negotiations, such as a project list 200, a task list 202, and recent documents list 203. The project list 200 presents a list of negotiations 210. The list of negotiations 210 may be presented in any suitable manner, such as a complete listing, a list in response to a set of search criteria, or a list for a particular user. The user may review various categories of strategic information relating to a particular negotiation from the project list interface 200, such as the starting date, the title 214, the counterpart 216 and the counterpart's company 218, personnel involved in the negotiation, date of last entry of information, and whether the negotiation has been completed.

The task list 202 and recent documents list 203 may provide lists and/or links for accessing task list entries and documents related to one or more negotiations. The task list 202 and recent documents list 203 may be automatically updated upon selection of a particular negotiation. For example, if the user selects a particular negotiation from the project list 200, the strategic negotiation system 100 may automatically present the tasks and most recently added or modified documents corresponding to the selected negotiation on the task list 202 and recent documents list 203, respectively.

The project list interface 200 may also present notes, such as the current status or ultimate result of the negotiation. The user may select a particular negotiation from the list of negotiations 210 for access, or may search the list of negotiations 210, for example using filter criteria. The filters may operate using any criteria, such as the title of the negotiation 214, the counterpart 216 or counterpart company 218, negotiations that are closed, or negotiations that have been active within a certain time period, such as the last thirty days, or dates of modification 222. New negotiation projects may be added by selecting the new project option 224, which clears the relevant fields for insertion of new information. Other additions may be made by selecting the desired type of addition, such as adding a company 226, a new contact 228, a new task 230, or a new template 232.

The strategic negotiation system 100 may also provide interfaces for managing contact information, such as information for counterparts and their companies. Contact information may be stored in any appropriate memory device, such as on the local storage system 116, in the database 122, or in a remote memory device accessible to a user via a network connection. In addition, the contact information may be stored and retrieved solely by the strategic negotiation system 100, or may interoperate with other programs to share information, such as with other contact management software, for example Microsoft Outlook or ACT!.

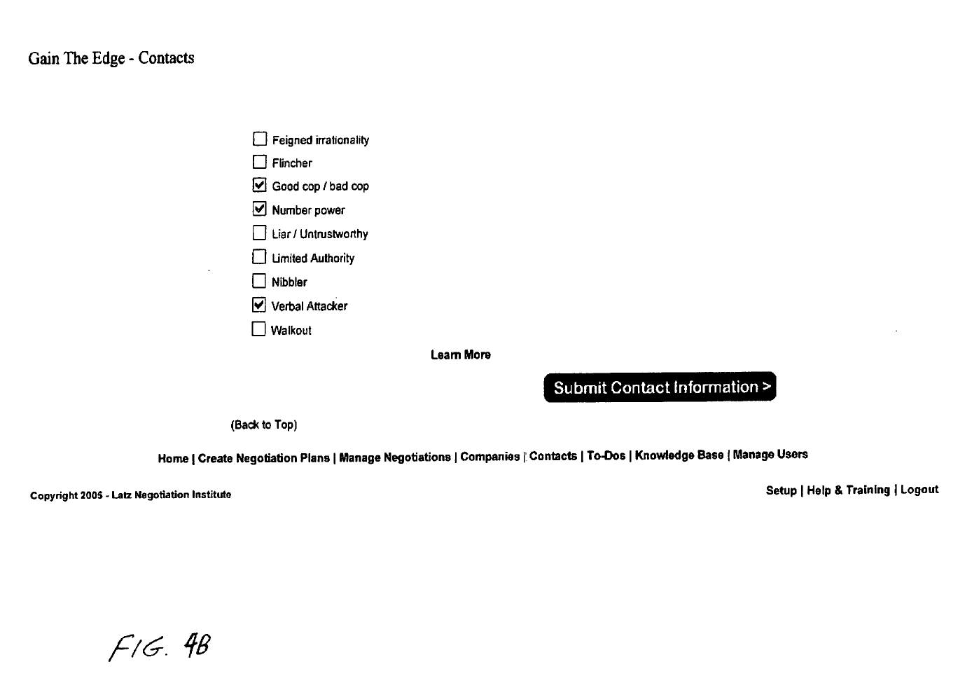

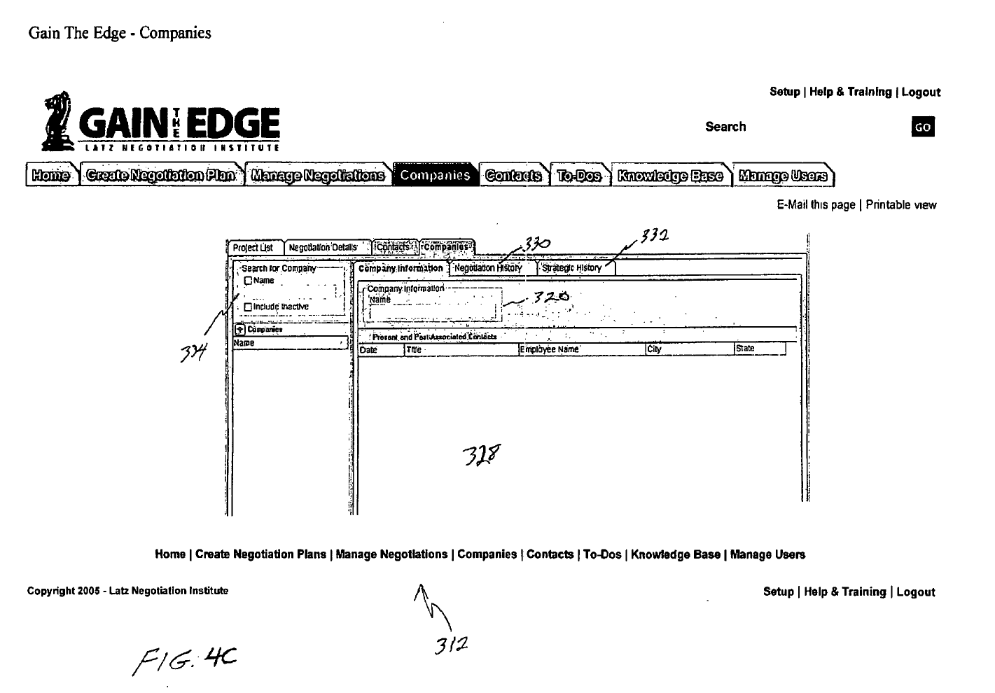

Contact information may be accessed via any appropriate interface or set of interfaces. For example, referring to FIGS. 4A-C, contact information interfaces 310, 312 for various people and companies, such as those involved in the negotiations listed in the list of negotiations 210, may include any suitable fields, such as names 320, telephone numbers 322, addresses 324, and the like. The contact information interfaces 310, 312 may also include information specific to the negotiations, such as current and previous personnel 328 and company associations, and user notes 318. The present contact information interfaces 310, 312 may further include additional fields for noting personal interests of various people, negotiation history 330 for companies, and strategic histories 332 for both companies and people. The strategic history 332 may include any suitable strategic information, such as the dominant negotiation style (e.g., competitor, accommodator, or conflict avoider), negotiating and strategy characteristics, or other appropriate notes that may assist users in understanding their counterparts and more effectively negotiating with them. The information relating to prior negotiations is suitably linked to strategic negotiation information relating to prior negotiations that may be accessed by the strategic negotiation system 100, such as previous negotiation project files stored in the database 122. In addition, the strategic negotiation system 100 may automatically populate various fields with information received from other parts or functions of the strategic negotiation system 100.

The contact information for personnel and companies is also suitably searchable, for example via one or more search fields 334. The search results may be provided in a list format to facilitate accumulation and comparison. For example, if a user is entering a negotiation with a particular company, the user may search for all personnel in the database associated with the company, which are listed in a contacts field. The user may then select different personnel listed in the contacts field to compare information relating to the various people.

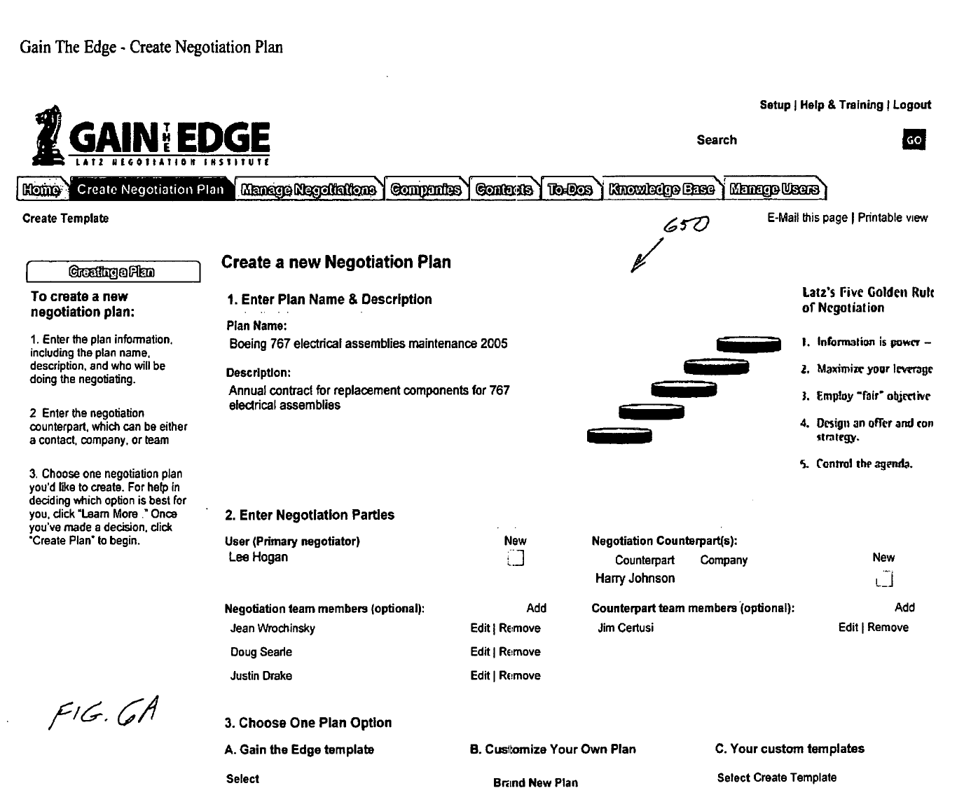

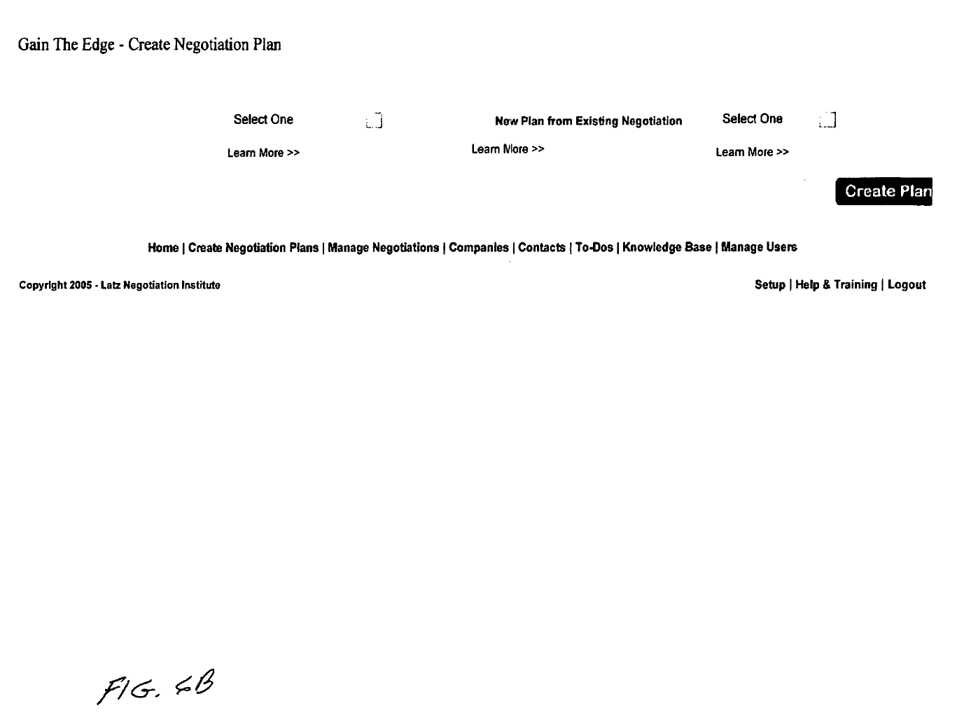

Referring to FIG. 6, the strategic negotiation system 100 may present a new negotiation interface 650 to process information relating to new negotiations. The new negotiation interface 650 may facilitate any suitable functions for entering strategic information relating to a new negotiation, such as to receive information regarding the subject matter of the negotiation, the responsible personnel, the counterparts in the negotiation, and planning details. The new negotiation interface 650 may perform any suitable functions assembling information and/or preparing a strategic plan relating to a negotiation. For example, the present new negotiation interface 650 is configured to assist in creating strategic negotiation plans, such as by using templates or forms.

To create a new strategic negotiation plan, the new negotiation interface 650 provides fields for entering any suitable strategic information relating to a negotiation, such as a plan name and description, names of the primary negotiator and team members, and counterparts or other parties. The new negotiation interface 650 may also facilitate preparation of the strategic negotiation plan, for example by permitting the user to select a standard template, a user-customized template, or an independent plan. If the user selects to create an independent strategic plan without using a template, the strategic negotiation system 100 suitably presents a planning interface for generating the independent plan. Likewise, if the user selects a standard or customized template, the strategic negotiation system 100 may retrieve and present the customized template for planning the negotiation.

The template may comprise any suitable interface for building a structured strategic plan for a negotiation based on predetermined issues and information, such as a list of issues and information relevant to the negotiation and tools for analyzing the issues and information for the negotiation. If the user selects to create a new template for negotiation planning, the strategic negotiation system 100 may present a template building interface configured to assist in generating a strategic negotiation planning template. The template building interface may provide candidate issues and information that the user may wish to address in the new template. The user may then select and/or enter issues and information for inclusion in the template, and the strategic negotiation system 100 may build the new template according to the user selections and entries.

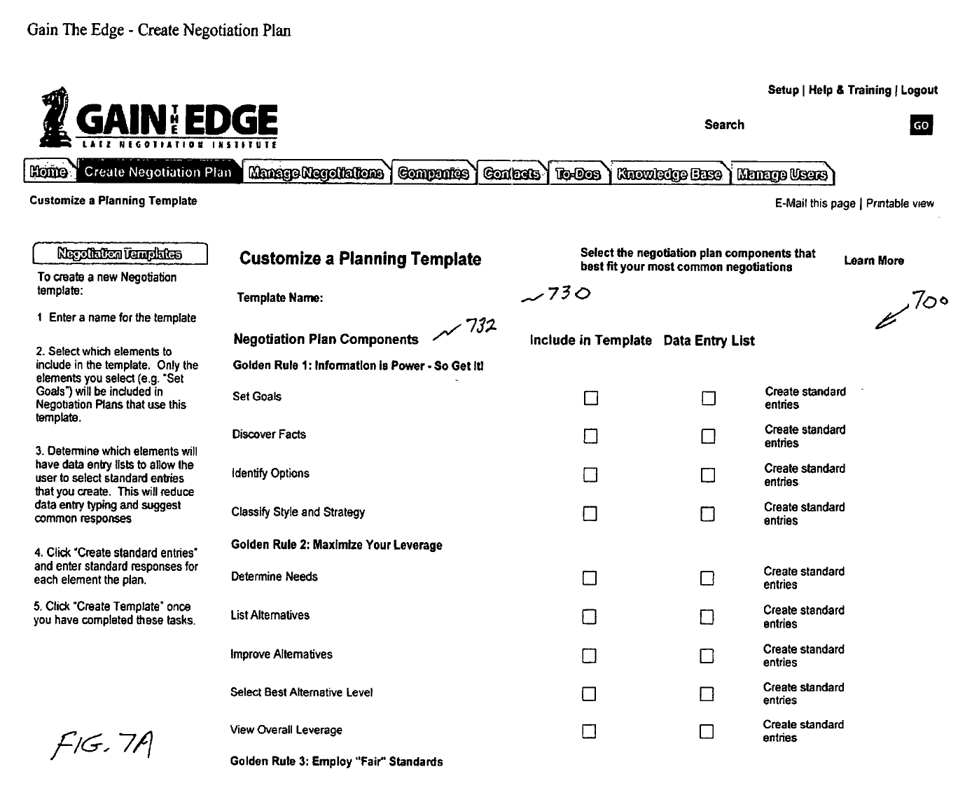

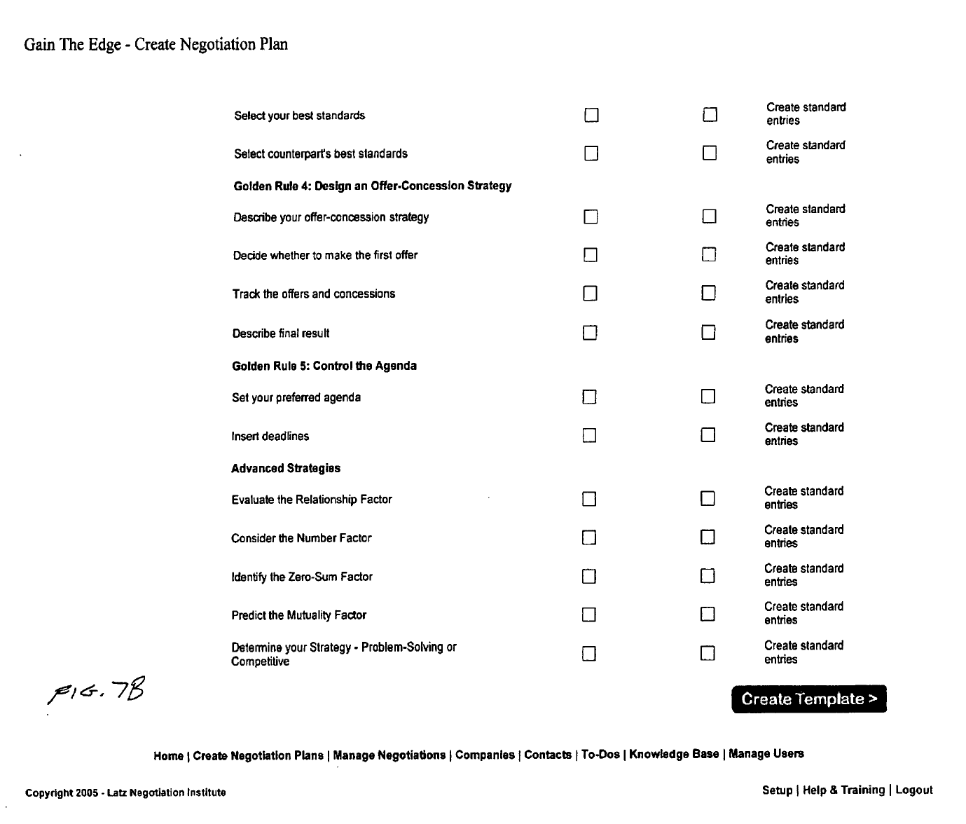

For example, referring to FIGS. 7A-B, the template building interface 700 of the present embodiment provides one or more areas for entering information relating to the template and allowing the user to select issues, information, and tasks to include in the template. The user may enter a name for the template in a template name field 730, and select elements to include in the new template from a list of negotiation plan components 732. The user may also select whether to include a data entry list for various components to allow additional information to be entered by the user. The user may also select to have a set of standard responses made available in the template to reduce data entry typing and suggest common responses. The user builds the new template according to the selected criteria by selecting the CREATE TEMPLATE button. The strategic negotiation system 100 automatically generates the customized template according to the information selected by the user. For example, the strategic negotiation system 100 may generate a template listing each of the elements designated to be included in the template. If the user selected to include a data entry list, the corresponding element is associated with a data entry list for the user to enter desired criteria relating to the relevant element. If the user also opted to create the standard entries, the strategic negotiation system 100 automatically populates the data entry list with a set of default entries.

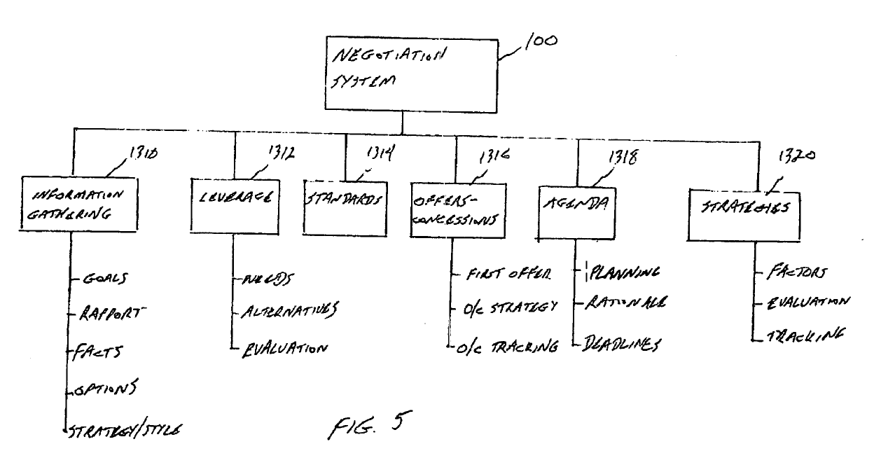

The negotiation functions are suitably implemented via one or more modules and controlled via one or more negotiation interfaces. The negotiation modules and interfaces may comprise, operate, and/or represent any suitable systems and techniques for gathering and analyzing information. For example, referring to FIG. 5, the present strategic negotiation system 100 focuses on five main negotiation functions: gathering information 1310, maximizing leverage 1312, establishing objective standards 1314, preparing and/or designing offer-concession strategies 1316, and controlling the agenda 1318. The strategic negotiation system 100 may perform the negotiation functions in any suitable manner.

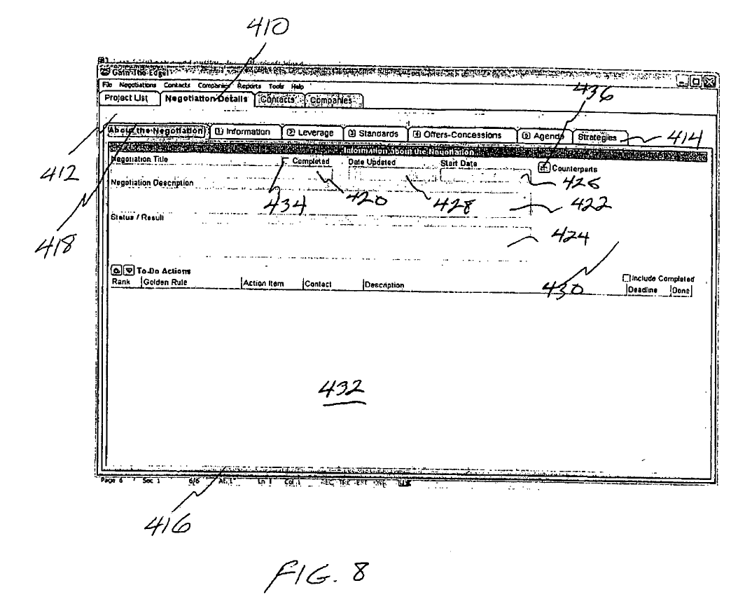

Referring now to FIG. 8, the strategic negotiation system 100 of the present embodiment presents a negotiation details interface 410 providing access to multiple interfaces dedicated to negotiation functions. The negotiation details interface 410 may address one or more negotiations, and the user may navigate among various negotiations using a set of navigation buttons 412 or other selection mechanism. The various functions are likewise accessed in any suitable manner, such as by selecting from a menu, a set of hyperlinks, or a series of tabs 414.

The various interfaces may address any suitable issues or fields. For example, the interfaces may be dedicated to the five main negotiation functions, as well as a general negotiation function and an advanced strategies function 1320 (FIG. 5), that may be implemented via corresponding software modules and accessed via tabs, hyperlinks, or other appropriate selection mechanisms. The general negotiation function is suitably implemented via a general negotiation module, which generates a general negotiation interface 416. The general negotiation interface 416 provides and/or prompts the user for general information about the negotiation. For example, the present general negotiation interface 416 includes fields for the negotiation title 420, a description of the subject matter of the negotiation 422, the status and/or result of the negotiation 424, start date 426 and date of last update 428 for the negotiation, the counterparts in the negotiation 430, a task list 432 of tasks to be performed for the negotiation, and a flag to indicate whether the negotiation has been completed 434. Each field may include sub-fields, such as a ranking of the tasks in the task list 432, a description of the tasks, a main negotiation function relevant to the task, contact information, a deadline for completion, and a flag for the status of the task, such as completed or not completed. The general negotiation interface 416, however, may include any appropriate or desired fields. New contacts may be added by selecting the new contacts option 436, which clears the relevant fields for insertion of new information.

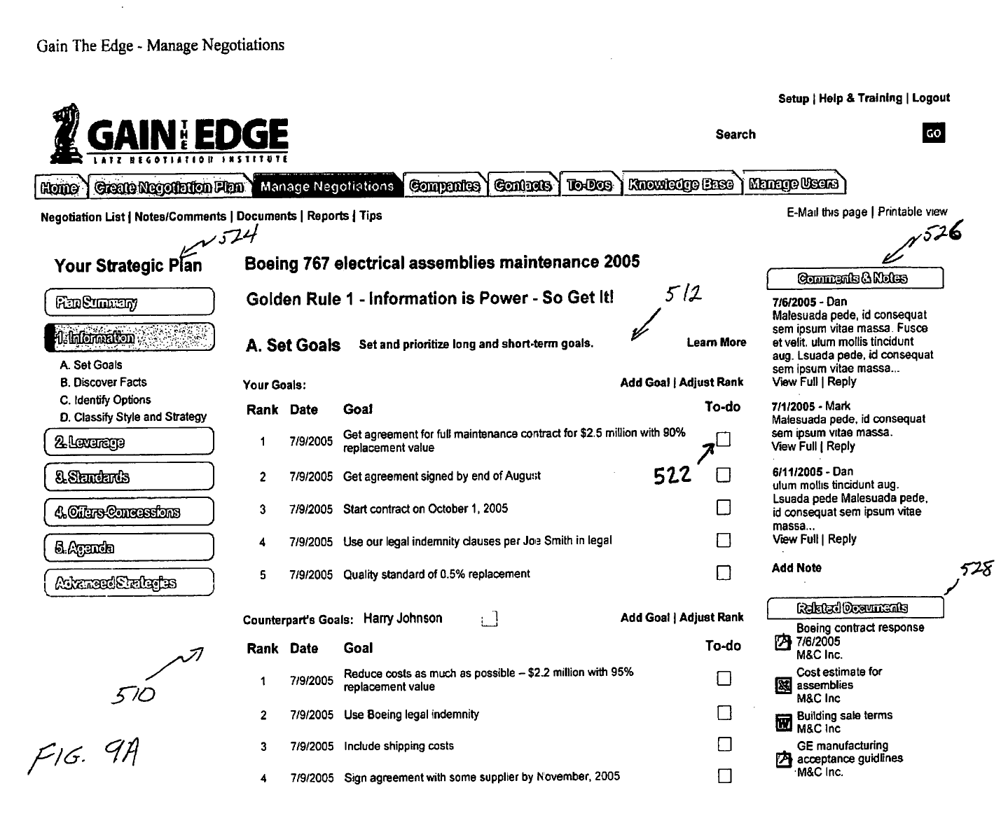

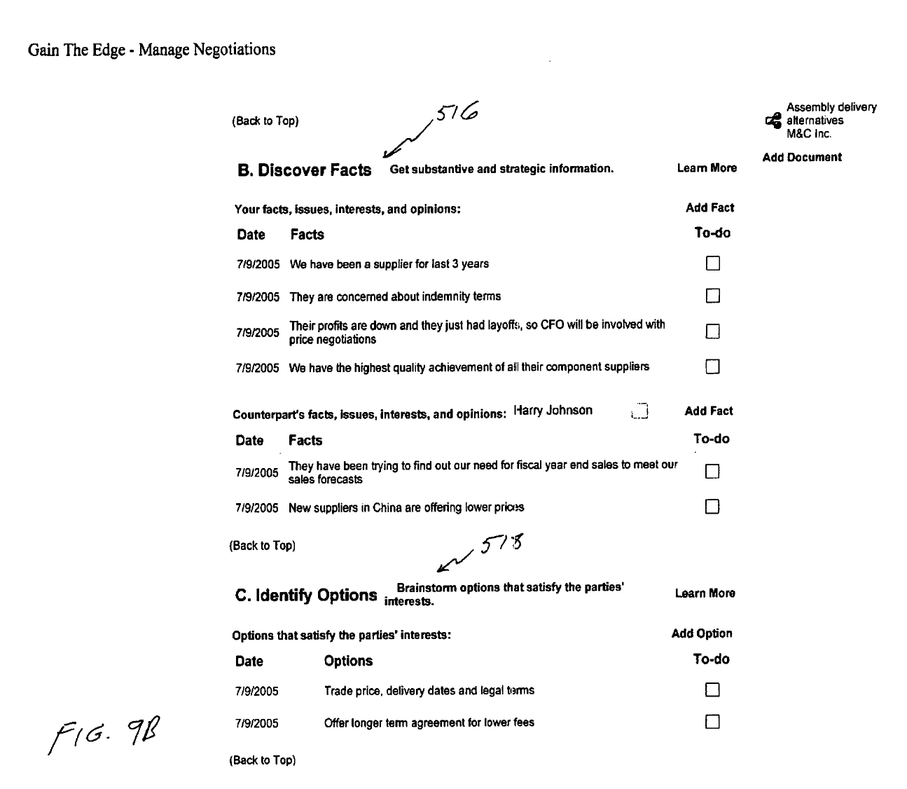

The main negotiation functions are configured to assist in strategically organizing and optimizing the negotiation. The main negotiation functions may comprise any suitable set of negotiations functions. Referring to FIGS. 9A-C, the first main negotiation function in the present strategic negotiation system 100, the information-gathering function, may be implemented via an information module, which presents an information-gathering interface 510 accessed via a tab or link marked INFORMATION. The information-gathering function is configured to facilitate collection of strategic information relating to issues that shape the negotiation. The issues addressed may be any relevant issues, such as the goals of the parties, actions for developing rapport between the parties, relevant facts, interests and opinions of the parties, possible options for resolution, and the counterpart's negotiation styles and strategies. In the present embodiment, the information-gathering module is configured to assist in the collection of strategic information, such as prompting the user, independently gathering information, and generating additional information. Further, the information-gathering module may be configured to discourage the user from entering negotiations solely with arguments intended to persuade the other side of the legitimacy of a position, but instead encourage the user to ask questions and seek to obtain strategically critical information before personally engaging their counterparts.

For example, the present information-gathering interface 510 is divided into multiple areas, such as a goals area 512, a rapport area, a facts area 516, an options area 518, and a style/strategy area 520. The information-gathering interface 510 may also display additional areas, such as a navigational area 524 to navigate among the functions, a comments and notes area 526, and a related documents area 528. The comments and notes area 526 may comprise any suitable system for displaying notes and/or comments, such as comments or notes relating to the negotiation. In the present embodiment, the comments and notes area 526 is a forum-type area allowing members of a negotiation team to post comments and notes relating to the relevant negotiation that may be viewed by all team members. Similarly, the related documents area 528 may present the most recently added or modified documents corresponding to the relevant negotiation, which may include links to open the corresponding document files.

The goals area 512 seeks to generate and record strategic information relating to the goals of the respective parties, such as setting and ranking the user's and the counterpart's goals in the negotiation. Goals may be set according to any suitable criteria, such as requesting aggressive, realistic, specific, and measurable goals. In the present embodiment, the goals area 512 provides for setting one or more goals for the user, including a description of the goal, the day the goal was established or updated, and an importance ranking of the goal. Requiring a specific description of the goal tends to promote the use of concrete, specific, and measurable goals that provide a benchmark to measure the progress of the negotiation and help managers assess and evaluate the success of their subordinates' negotiations. The specific description also promotes the setting of aggressive goals, as it requires the user to determine what the user desires from the negotiation. The goal may also be associated with a task for a task list, for example by setting a “ToDo” flag 522, which may generate a prompt for entry of a task on the task list 432. When the task is entered, it is automatically placed on the task list 432 along with selected information relating to the task.

The goals area 512 also provides for determining the goals of the counterpart. The goals area 512 provides for entry of specific descriptions of the counterpart's probable goals, the day the goal was established or updated, and a probable importance ranking of the goal. Ordinarily, the user may not know of some or all of his counterpart's goals, but may attempt to generate the probable goals and estimate the desire to achieve those goals by analyzing the negotiation from the counterpart's perspective.

The information-gathering interface 510 may also include the rapport area. In many negotiations, the parties tend to agree more readily with others when they exhibit similar characteristics and qualities. Thus, the rapport area may be configured to find rapport-building common personal interests between the parties. For example, the rapport area is configured to generate and track information for building personal and/or professional rapport by finding common interests. The rapport area may include areas to describe the common interests that may be shared by the user and the counterparts, such as common friends, common backgrounds or experiences, common likes and dislikes, etc. The rapport area may also provide for adding tasks to the task list in pursuit of building rapport.

The information-gathering interface 510 may further include the facts area 516 dedicated to identifying facts that may be relevant to one party or multiple parties. On the user side, the user identifies the facts, issues, interests, and opinions relating to the counterpart's positions, especially fundamental interests underlying those positions. For example, the interests may include the counterpart's needs, desires, concerns, fears, or other factors that motivate parties, such as ego, security, economic well-being, an appraisal of the relative importance of these things about the counterpart's position. Likewise, the user may perform a similar analysis for the user's position. For example, the user may determine and list all the facts, issues, interests, and opinions relating to the negotiation and that the other side might want to know, including the interests supporting those positions.

The options area 518 of the information-gathering interface 510 may request information regarding options that may satisfy the interests of the parties. In many instances, multiple options that satisfy the parties' interests may be available, which may be ranked by the user according to the user's preferences. The options area 518 provides data entry fields for entering descriptions of the possible options to satisfy the parties' interests, along with dates and associated tasks.

The information-gathering interface 510 further suitably includes the style/strategy area 520 for analyzing and recording the counterpart's style and strategy. The style/strategy area 520 collects strategic information relating to the methods used by the counterpart to negotiate. The strategic information relating to the counterpart's strategy and style may be retrieved from any suitable source, such as information from prior negotiations retrieved from the database 122 or new information received from the user based on personal experience or the experiences of others. The style/strategy area 520 may collect the strategic information in any appropriate form. In the present embodiment, the strategy/style area 520 includes a set of pre-selected categories of negotiation styles, such as bluffer, context manipulator, feigned irrationality, flincher, good cop/bad cop, liar/untrustworthy, limited authority, nibbler, number power, verbal attacker, and walkout. The counterpart may exhibit one or more of these characteristics, which may be noted in the strategy/style area 520. The strategy/style area 520 may further include an area for notes relating to the counterpart's style and strategy.

The information in the strategy/style area may be used by the information module to formulate an appropriate response and negotiation strategy. For example, the information module may provide strategies for dealing with a negotiator using the selected styles and strategies. The information module may also retrieve from the database 122 information regarding how such styles and strategies have been dealt with in the past, and the extent to which such responses were successful.

The negotiation functions also suitably include a leverage function for assessing and enhancing the leverage for the user. Leverage fundamentally relates to how easy it is for one party to walk away from the negotiation relative to how easy it is for the other party to walk away. The easier it is for one party to walk away and the harder for the other party, the stronger the leverage for the first party, and vice versa. The leverage function may address any suitable factors relating to the relative leverage of the parties, such as how much each party needs or wants an agreement relative to the other, the consequences to each side if no agreement is reached, and each side's alternative to a negotiated agreement.

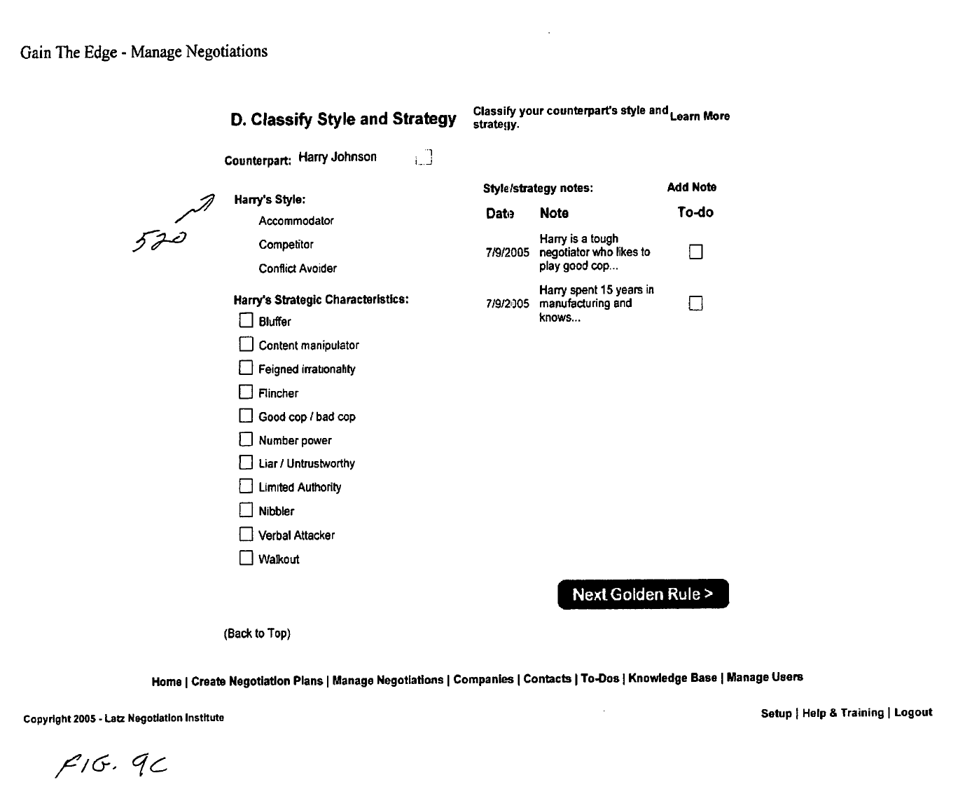

Referring to FIGS. 10A-D, in the present strategic negotiation system, the leverage function is implemented via a leverage module, which presents a leverage interface 610 accessed via the link or tab marked LEVERAGE, which causes the leverage module to present the leverage interface 610 for assessing and maximizing the user's leverage. For example, the leverage module may include systems for determining the relative need of the parties, identifying alternatives to dealing with the other party, and assessing the relative leverage of the parties.

For example, the leverage interface 610 may include fields for entering the level of need for each party. In the present embodiment, the leverage interface 610 includes a DETERMINE OUR NEED field 612 that allows the user to enter an assessment, such as five levels of need between VERY LOW to VERY HIGH, of the user's need for something from the counterpart. The leverage interface 610 includes a corresponding DETERMINE COUNTERPART'S NEED field 614 for entering the counterpart's probable need for something from the user. Based on these assessments, the strategic negotiation system 100 may compute the relative needs of the parties, for example on a scale of weakest (−4) to strongest (+4).

Leverage is also a matter of available alternatives. Accordingly, the leverage module may include systems for determining the availability of alternatives. For example, the present leverage interface 610 includes LIST ALTERNATIVES fields 616, 618 for listing alternatives to a negotiated settlement for each party. The alternatives may be described and associated with a rank, a date, and a task on the task list. In addition, the leverage interface 610 may include an IMPROVE ALTERNATIVES area 620, 622 for listing one or more steps that may be taken by the user to convert the various alternatives into practical possibilities or enhance their attractiveness to the user and/or to limit the attractiveness of various alternatives available to the counterpart, and the various steps may be memorialized with a description, a date, and a task on the task list 202, 432.

The leverage module may facilitate analyses of the acceptability of the various alternatives. For example, the present leverage interface 610 provides a user's best alternative field 624 for entry of the user's best alternative and a counterpart's best alternative field 626 for entry of the perceived best alternative for the counterpart, which is suitably automatically inserted according to the rankings provided in the respective lists of alternatives. The quality of the respective alternatives may also be described by the user in a user's quality level field 628 and a counterpart's quality level field 630, such as by rating the quality of each alternative according to seven levels between VERY POOR and EXCELLENT.

The leverage module may also analyze the overall relative leverage of the parties according to the leverage information. The leverage module may assess the relative leverage according to any suitable algorithm, such as by comparing the respective levels of need of the parties, the availability of alternatives, the acceptability of such alternatives, and any other suitable criteria, and may generate a leverage value representative of the relative leverage of the parties. In the present strategic negotiation system 100, values assigned to the various factors may be summed to arrive at an overall leverage value. For example, the user's need may be assigned a value between −2 for having a very high need and +2 for having a very low need. Likewise, the counterpart's need may be assigned a value between +2 for a very high need and −2 for a very low need. Summing these values generates a relative need value such that a negative value reflects a lower leverage for the user and a positive value reflects a higher leverage. Similarly, the user's best alternative may be assigned a value between +3 for being an excellent alternative and −3 for being a very poor alternative. Conversely, the counterpart's best alternative may be assigned a value between −3 for an excellent alternative and +3 for a very poor quality alternative. Summing these need and alternative values generates an overall leverage value between +10, indicating that the user has very strong leverage, and −10 corresponding to very weak leverage for the user. The various factors used to determine leverage may be weighted according to their importance so that more important factors affect the calculation more significantly. The overall leverage may be presented on the leverage interface 610, for example using a graphic representation of a sliding bar scale 632.

In many negotiations, a party may cite fairness as a basis for requesting a particular term of an agreement. Fairness often corresponds to relatively objective standards, such as market value or precedent, which ensure an acceptable, “fair and reasonable” result. If multiple sides can agree on an independent standard that is fair and reasonable, the negotiation tends to progress. Accordingly, the strategic negotiation system 100 may assist in establishing standards that may promote agreement, particularly standards that may favor the user or opposing standards that promote the counterpart's position. Further, identification of appropriate standards tends to ensure that the negotiation proceeds according to relatively independent and objective criteria, reducing the emotional component of the negotiation and increasing the likelihood that the parties will view the result as fair and reasonable. Using objective standards also provides a good-faith basis for offers and concessions, and increases the likelihood specific offers and concessions will be accepted.

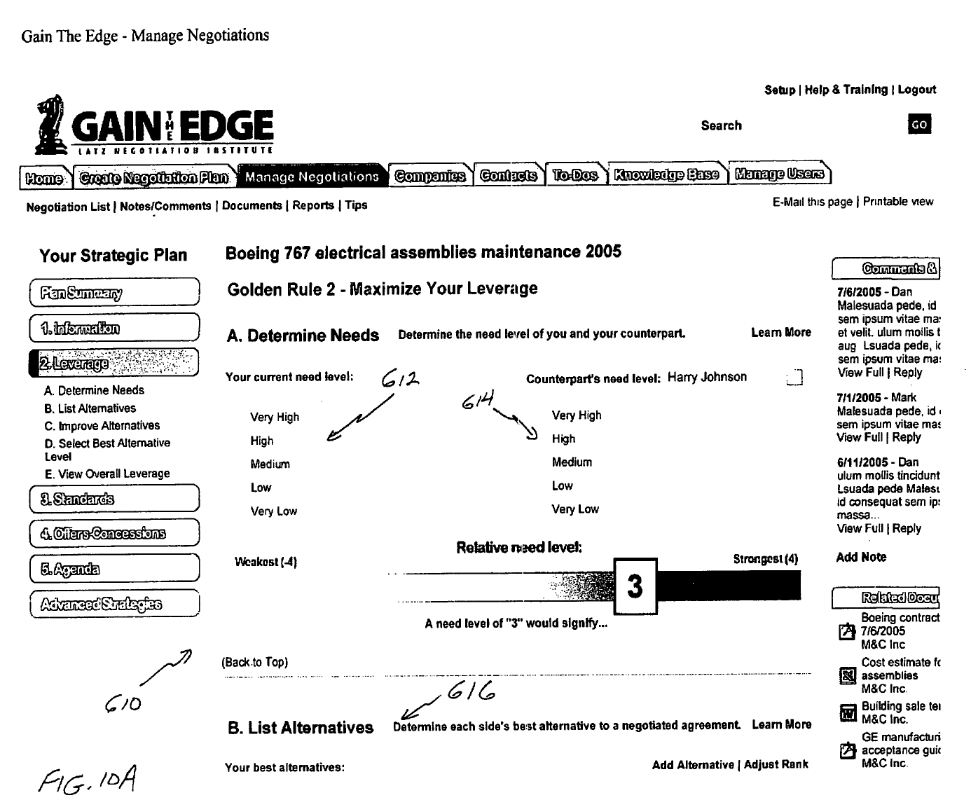

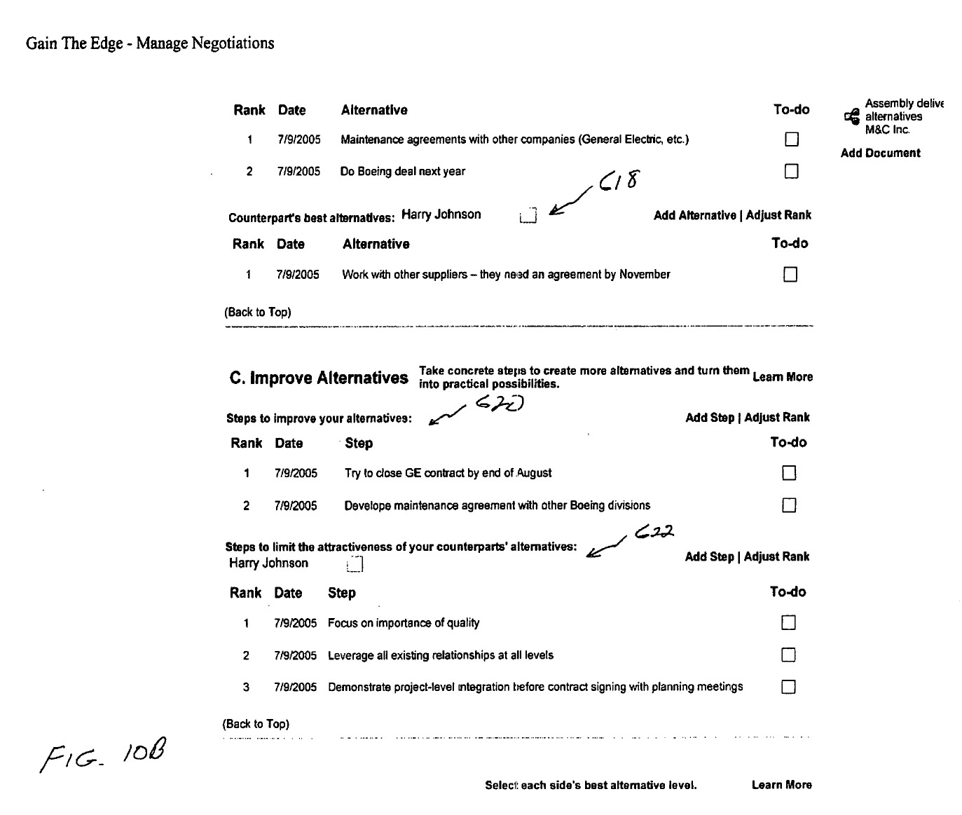

For example, referring to FIG. 11, the negotiation functions may include a standards function that may be implemented via a standards module and accessed via a standards interface 710, such as via a STANDARDS link or tab 712. The standards module may comprise and/or facilitate any appropriate system for identifying standards that support the user's position and/or weaken the counterpart's position. In addition, the standards module may assist in tracking the most useful and powerful standards used. Further, the standards module may analyze the standards in conjunction with and compared to the goals entered by the user to assess whether the goals are realistic in view of the applicable standards.

In the present embodiment, the standards interface 710 provides standards information, such as multiple candidate standards 714 or other information relating to relevant or potentially relevant standards, that may be used by the parties, such as costs/profit margin, efficiency, expert/scientific judgment, market value, policy, precedent, professional or industry standards, reciprocity, status power, tradition, or other appropriate standards. The standards interface 710 may also include a user's standards area 716 for listing, ranking, and storing the applicable standards that support the user's position. Each standard may be associated with a date, a type of standard, a description of the applicable standard, and a task to be placed on the task list that may enhance the attractiveness of using the standard, such as performing research or identifying an appropriate expert. Similarly, the standards interface 710 may include a counterpart's standards window 718 for likewise listing, ranking, and storing the standards that support the counterpart's position, as well as corresponding dates, standard types, descriptions, and tasks that may be undertaken to counter the effectiveness of the standard, such as impeaching the credibility of an expert or researching the validity of the counterpart's assumptions supporting the use of the standard.

The offer-concession function of the present strategic negotiation system 100 assists in designing a strategy for pursuing offers and concessions to advance the negotiation. For example, an offer-concession module may assist in deciding whether to make a first offer or wait for the counterpart to do so. Further, the offer-concession module may assist in planning an offer-concession strategy and projecting the counterpart's offer-concession process. The offer-concession module may also facilitate tracking offers and concessions as the negotiation progresses, for example by recognizing certain offer-concession patterns that may be practiced, such as betting against oneself or alternatively making offers and concessions, as well as the final result of the negotiation. This information may be stored in the database 122 for later reference, comparison to other negotiations, and analysis.

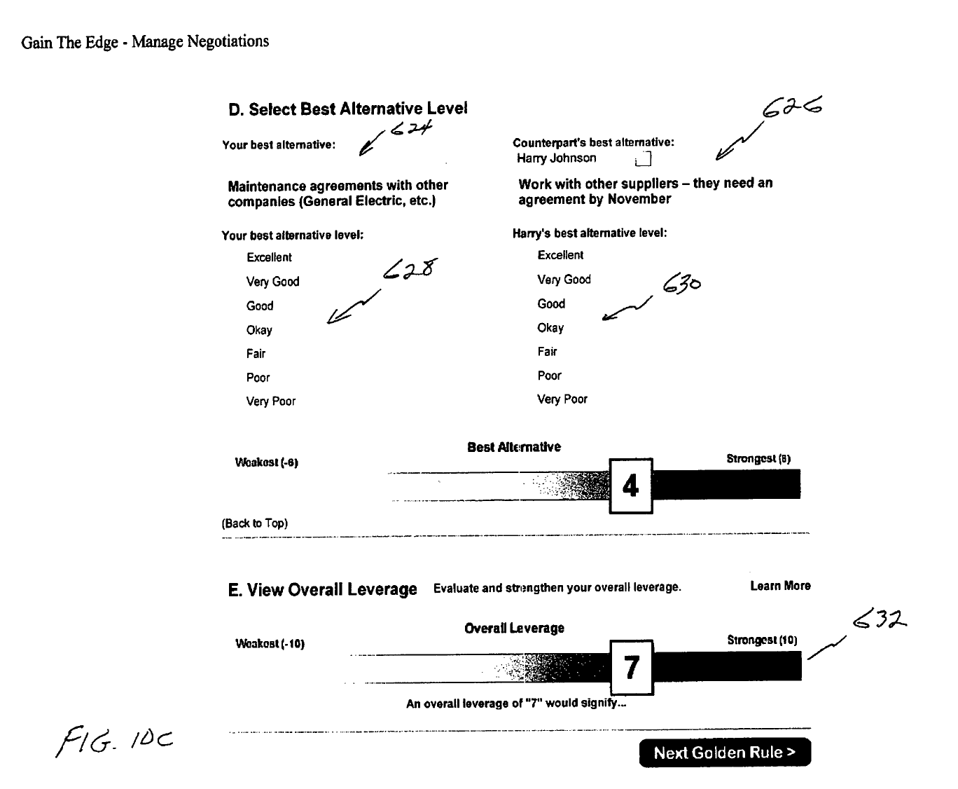

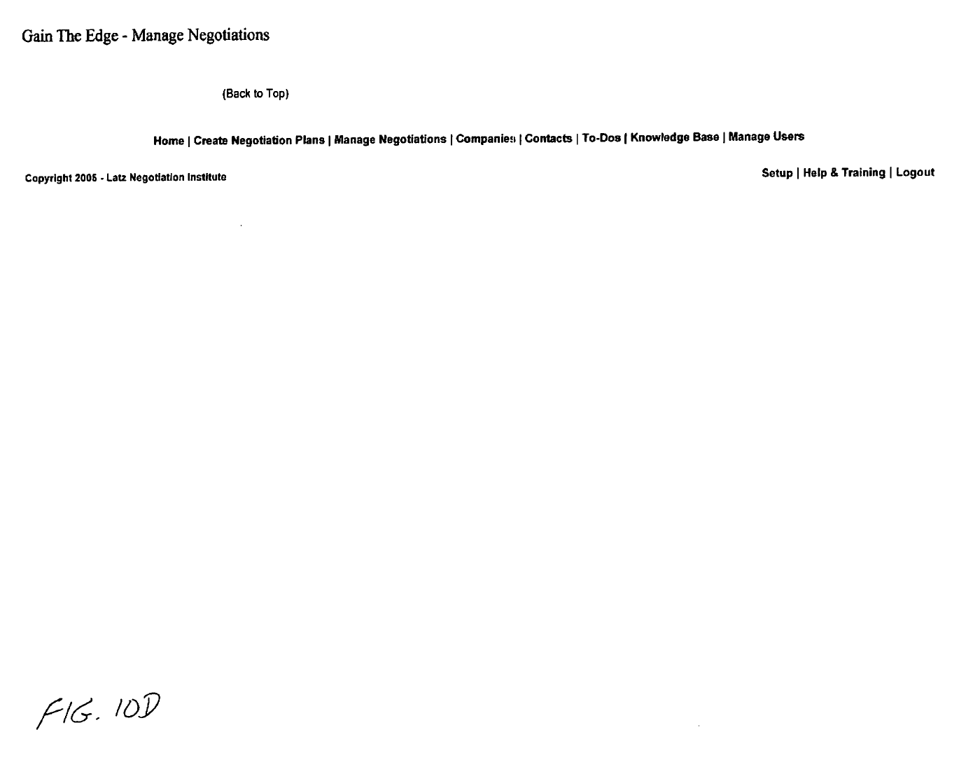

The offer-concession function may control or assist the offer-concession process in any suitable manner, such as by providing advice, organizing strategic information, researching options and strategies, and the like. For example, referring to FIG. 12, in the present embodiment, the offer-concession module generates an offer-concession interface 810, such as via a link or tab marked OFFERS-CONCESSIONS 812. The offer-concession interface 810 may provide any suitable information or functions for planning, predicting, tracking, and strategizing for offers and concessions in the negotiation. For example, the present offer-concession interface 810 provides access to a first offer planner, an offer-concession strategy planning system, and an offer-concession tracking system.

More particularly, the first offer planner allows the user to decide and may provide advice regarding whether to make a first offer. In the present embodiment, the first offer planner lists various advantages and disadvantages to making the first offer 814. Advantages may include, for example, setting expectations and the tone for the negotiation, eliciting reactions from the counterpart, and establishing a timetable for the negotiation. Disadvantages may include making an inappropriate first offer due to a lack of information and providing useful strategic information to your counterpart. The various advantages may be analyzed by the user and/or automatically by the first offer planner. For example, the various applicable advantages and disadvantages may be ranked and analyzed for applicability to the current negotiation. The first offer planner may then analyze the relative importance of the various advantages and disadvantages and/or compare the pattern of applicable advantages and disadvantages to negotiations in the database 122 and their results, and offer guidance to the user accordingly. The first offer planner may also search the database 122 for prior negotiations having similar characteristics and analyze the results of such cases to determine whether a particular first offer strategy has previously met with reliable success. The user may then select whether to make the first offer accordingly.

The offer-concession strategy planning system assists the user in preparing an offer-concession plan and/or anticipating the counterpart's offer-concession pattern. The offer-concession strategy planning system may operate in any suitable manner to plan and/or predict the offers and concessions in the negotiation. For example, the offer-concession interface 810 assists the user in planning an offer-concession strategy by starting with the user's goal and requiring the user to describe how the user intends to achieve the goal through the user's offers and concessions in a user's offer-concession strategy area 816. The strategy may include any appropriate information, such as timing regarding when the offers and concessions should be made and the amount of time that should elapse between offers and concessions, the size of the offers and concessions, the standards used to justify the reasonableness of the offers and concessions, and the user's expectations in the negotiation context. The offer-concession interface 810 may also include a counterpart's offer-concession strategy area 818 for a description of the counterpart's anticipated offer-concession strategy.

For example, the offer-concession interface 810 may prompt the user to describe the counterpart's anticipated offer-concession strategy, for example by starting with the counterpart's probable goal and then describing how the counterpart appears to intend to achieve the goal through offers and concessions. The description may include any relevant information, such as the anticipated timing and size of the offers and concessions, the anticipated standards used to support the reasonableness of the offers and concessions, and the counterpart's anticipated expectations from the offer-concession process.

In addition, the offer-concession strategy planning system may facilitate research to develop an appropriate offer-concession strategy. For example, the offer-concession strategy planning system may search the database 122 for relevant data, such as previous negotiations with the counterpart company and/or personnel, relating to similar subject matter, or having similar goals. The offer-concession strategy planning system may analyze the data for such prior negotiations and identify those strategies that were successful and unsuccessful, and provide the analysis results to the user for assistance in crafting an appropriate offer-concession strategy. The offer-concession strategy planning system may identify patterns in previous negotiations, such as timing patterns that may generate a perception of desperation or antipathy, the size of concessions made at different times as the negotiations progress, tendencies to gravitate towards a median number between early offers, responses to demands for reciprocity in concessions, and willingness to split the difference to resolve issues.

The offer-concession tracking system tracks the actual offer and concession process as the negotiation proceeds. The offer-concession tracking system may be implemented in any suitable manner to track the progress of offers and concessions, such as in conjunction with a series of dates annotated with descriptions, both financial and non-financial, of the offers and concessions made by the various parties. In the present embodiment, the offer-concession interface 810 includes an offer-concession list 820 having various fields, such as for the date, the party making the particular offer and concession, the amount or size of the offer or concession, and a description. The offer-concession tracking system may perform additional analysis, such as plotting the response times between the offers and concessions and the sizes of the offers and concessions, which may assist the user to identify patterns in the user's or the counterpart's offer-concession behavior. The user may also enter the final result of the negotiation in a FINAL RESULT field 822, which may describe a deal that is reached or how the negotiation otherwise concluded, such as a description of the final offer that was proposed by either party that was accepted.

The negotiation functions also suitably include an agenda function for planning a process for addressing issues in the negotiation. Whether, when, where, how, and how long the parties address issues may affect the result of the negotiations, as does setting an appropriate atmosphere in which to most effectively explore the substantive issues. An agenda module implementing the agenda function suitably assists in preparing and promoting an agenda that supports the user's interests.

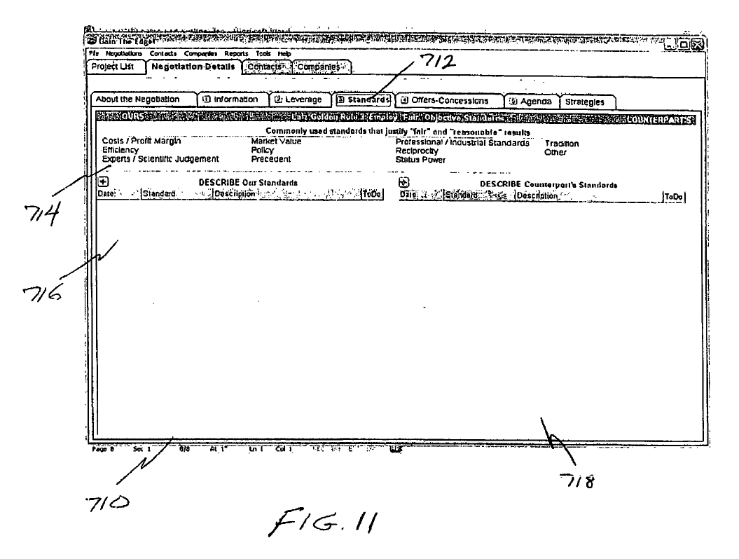

Referring to FIG. 13, the agenda module presents an agenda interface 910 accessed via an AGENDA tab 912. The agenda interface 910 may offer any suitable functions to assist the user in establishing a favorable agenda. For example, the agenda interface 910 suitably includes systems for planning and promoting a favorable agenda, anticipating the counterpart's agenda and arguments for using it, and identifying relevant deadlines. The present agenda interface 910 includes a user's preferred agenda area 914 for planning the user's proposed agenda and a counterpart's preferred agenda area 916 for predicting the counterpart's agenda. More particularly, the user's preferred agenda area 914 includes fields for listing and prioritizing the issues that the user wishes to address. The issues may be associated with any other information, such as dates of entry and tasks for the task list. The user may prioritize the issues according to any suitable criteria, such as times at which the issues are most likely to be resolved favorably for the user. The user may also include information relating to the issue, such as if, when, where, how and how long to address the various issues.

The agenda may also be adjusted according to strategic information provided in conjunction with other negotiation functions, such as information regarding the counterpart's agendas and time interests acquired in conjunction with the information gathering function, the relative leverage of the parties determined via the leverage function, historical agendas or standard agendas that may be identified using the standards interface, and/or according to the offer-concession strategy prepared with the offer-concession interface. The counterpart's preferred agenda area 916 also includes an area for predicting an agenda likely to be desired by the counterpart. The user enters the issues that appear to be important to the counterpart and the likely timing for addressing those issues to have them resolved in favor of the counterpart.

The agenda interface 910 also suitably includes rationale fields 918, 920 for describing the respective rationales of the parties for following their particular agendas, which may assist the user in persuading the counterpart to proceed according to the user's agenda and anticipate the counterpart's opposing arguments. The agenda interface 910 of the present embodiment further includes deadline areas 922, 924 for setting mutual deadlines, such as deadlines imposed by a third party or mutual consent, as well as deadlines asserted by the user and the counterpart. In particular, the deadlines areas 922, 924 may include the dates of the deadline and descriptions of what needs to be done to meet the deadline. The deadlines may also be associated with tasks that are automatically placed on the task list. The deadlines may be selected according to any suitable criteria, such as historically satisfactory deadlines as established from the database, desires to increase pressure, tension, and competitiveness, needs for a future relationship, losses associated with the passage of time, and the value of possible creative solutions.

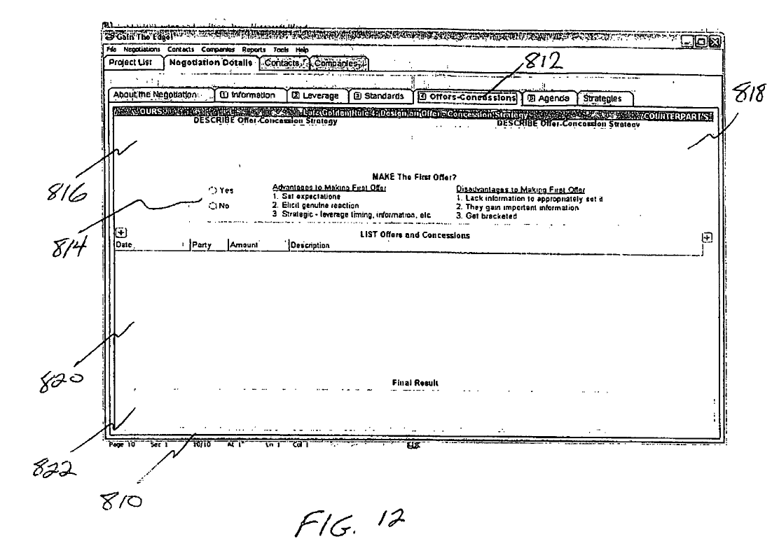

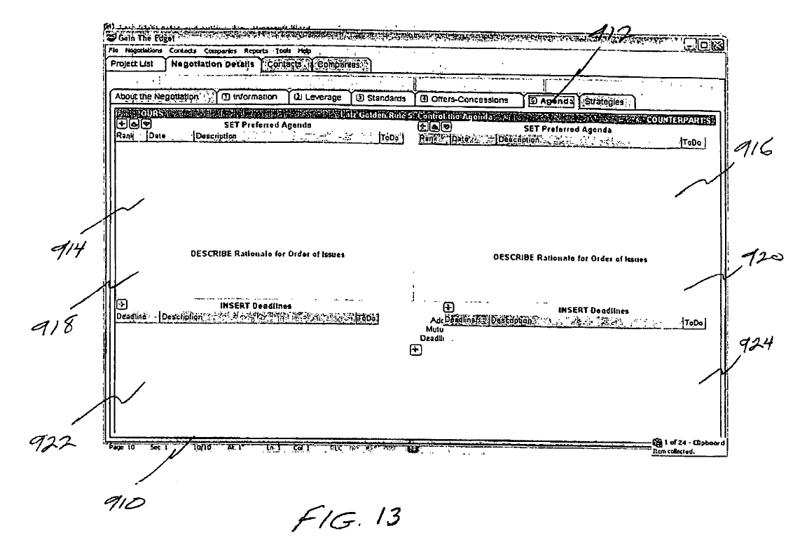

The negotiation functions may also include an advanced strategy function 1320 for formulating an advanced strategy for the negotiation. Referring to FIG. 14, the advanced strategy may be formulated according to any suitable criteria, and an advanced strategy module may present an advanced strategy interface 1010, accessible via a STRATEGIES link or tab 1012, and may provide any appropriate functions for establishing an appropriate advanced strategy. For example, the present advanced strategy module includes systems for evaluating the negotiation for possible strategies, making recommendations for strategies, and tracking effective strategies. Various factors may affect the particular type of negotiation strategy recommended by the strategies module and adopted by the user.

More particularly, the advanced strategy module may assess the negotiation to establish suitable negotiation strategies, and may request appropriate information. For example, the present advanced strategy interface 1010 includes an advanced strategy factors area 1014 for entering strategic information relating to various issues that may affect the advanced strategy selection, such as whether a future relationship is expected between the parties, the number of issues involved, whether the parties share common or compatible interests or the negotiation is likely to be dominated by zero-sum issues (where more for one side necessarily means less for the other), and whether the counterpart is willing to adopt less aggressive strategies. The advanced strategy factors area 1014 may request any other information that may be relevant to selecting an advanced negotiation strategy.

The types and features of advanced strategies recommended by the advanced strategy module may include any suitable advanced strategies for negotiations. For example, in the present embodiment, the advanced strategy module recommends advanced strategies according to a sliding scale 1016 having problem-solving strategies at one end and competitive strategies at the other. Problem-solving strategies are characterized by strategies and tactics focused on building trust, strengthening relationships, and promoting an atmosphere where the parties can work together to find a mutually satisfactory solution, such as negotiations between family members or long-term business partners. Competitive strategies, on the other hand, are often found where no future relationship is expected, such as when negotiating a house or used car purchase, and in adversarial situations where the parties seek to undermine confidence in the other's bargaining position and promote the perception of strength in their own bargaining position.

The advanced strategy module may analyze the information to assist in establishing an appropriate advanced strategy. For example, the advanced strategy module may assign values to the strategic information provided by the user. In the present embodiment, values may be assigned according to whether a future relationship is anticipated, for example ranging between +4 for a likely future personal relationship, lower values for varying degrees of professional relationships, and −4 for no future relationship at all. Similar values may be assigned according to the number of negotiated issues, ranging from +3 for several issues to −3 for few negotiated issues, as well as +3 for a negotiation likely to be free of important zero-sum issues to −3 for those likely to be dominated by zero-sum issues. The relative values may be selected to give greater weight to particularly important issues. For example, the possibility of a future relationship is often of more significance in selecting a negotiation strategy than the number of issues involved, so the relationship factor receives a greater range of possible values than the number of issues factor. Similarly, certain circumstances may suggest adjusting the overall sum. For example, if the counterpart is unwilling to negotiate using less aggressive negotiation techniques, a value of −10 may be assigned, because a problem-solving strategy is typically ineffective if the other party insists on using a competitive strategy.

The values may then be summed and compared to various types of strategies. If the sum is very positive, such as +9 or +10, the strategy module may recommend a problem-solving strategy. If the sum is very negative, such as −10 or more, the strategy module may recommend a competitive strategy. Intermediate sums may suggest a variation or combination of problem-solving strategies or competitive strategies.

The selection of the particular advanced strategy may prompt the user and/or the strategic negotiation system 100 to examine the other negotiation functions. For example, if the user selected a problem-solving strategy, the user may wish to openly and honestly share information about goals, issues, and fundamental interests and priorities, and ensure that the information sharing is mutual (information-gathering function); avoid overt leverage-related tactics, such as walkouts, that may harm a stable long-term relationship, and avoid explicitly discussing alternatives to an agreement with the counterpart (leverage function); focus on independent standards and rely on them as the basis for a solution (standards function); adopt a reasonable and unaggressive-appearing offer-concession strategy (offer-concession function); openly discuss the relevant issues and negotiate an agenda to start without imposing short deadlines designed to increase pressure (agenda function). Conversely, if the user adopts a competitive strategy, the user may restrict the information provided to the counterpart and independently investigate information received from the counterparts (information-gathering function); maximize and emphasize leverage and seek to change the perception of the other side about its leverage, and possibly engage in risky leverage tactics, such as threats, walkouts, bluffing, and “take it or leave it” offers (leverage function); rely less on independent standards and use them instead as tools to try to change the other side's perception of their leverage (standards function); employ aggressive offer-concession behavior, such as a first offer outside the range of any reasonable, standard-based result, or a long negotiation over which party even makes the first offer (offer-concession function); and try to control the agenda and impose deadlines to gain an advantage (agenda function).

The strategy interface 1010 may also include a strategy tracking area 1018 for tracking the effectiveness of various strategies. For example, the strategy tracking area 1018 may include one or more fields for listing the most effective negotiation strategies used by the user and the counterpart in the negotiation and the negotiation lessons learned from their use. The user may also describe the impact—positive or negative—that resulted from the user's or the counterpart's use of the identified negotiation strategy. The information so recorded may assist in improving the skills of the user or other potential users having access to the database and preserves information for the next time the user negotiates with the same counterpart and with others in similar negotiation situations.

The strategic negotiation system 100 may provide any other functions that may be appropriate for the particular application or environment, and may provide the functions in any suitable manner. For example, in the present embodiment using graphical user interfaces for various functions, several functions may be accessible via a conventional menu bar, set of links, or set of tabs. Each menu may provide access to various functions. For example, a menu bar 1020 of the present embodiment includes a file menu, a negotiations menu, a tools menu, and a help menu, which may provide access to any suitable functions relating to file management, negotiation project management, system management, and technical support, respectively. In addition, the menu bar 1020 may include a documents menu, contacts menu, and a companies menu for viewing lists of documents, contacts, and companies in the database relating to one or more negotiations, as well as for adding and removing entries from the respective lists.

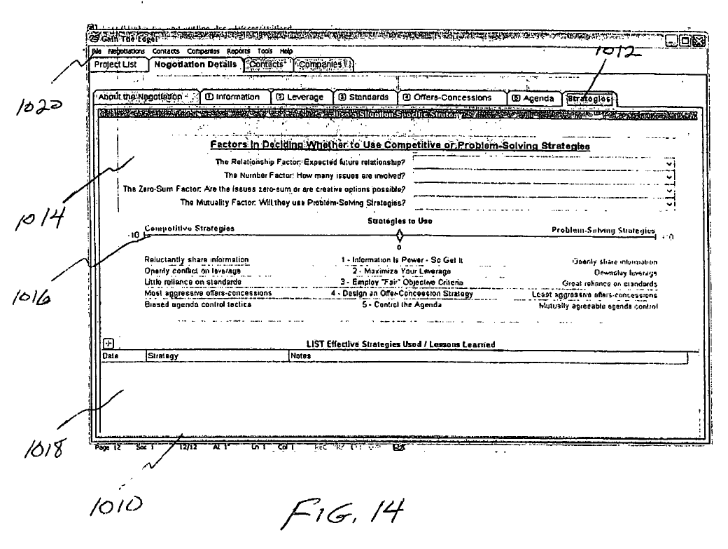

In the present embodiment, the strategic negotiation system 100 includes a knowledge base to provide information relating to negotiations, guidance to users, updates on negotiation activities, and the like. For example, referring to FIG. 15, the strategic negotiation system 100 may present a knowledge base interface 1510. The knowledge base interface 1510 provides links or other access to various information, such as strategic information relating to initiating a negotiation, guidelines for negotiating, negotiation strategies and best practices, and other resources for negotiation information. The knowledge base interface 1510 may include any suitable information that may be desired by the user.

The strategic negotiation system 100 may also provide administration functions for managing access to and use of the strategic negotiation system 100. The administrative functions may include any appropriate functions for managing the strategic negotiation system 100, such as functions for controlling access to the strategic negotiation system 100, structure of the system and resources, and establishing, modifying, and deleting user accounts. The administrative functions may also facilitate analysis of the performance of various personnel using the strategic negotiation system 100.

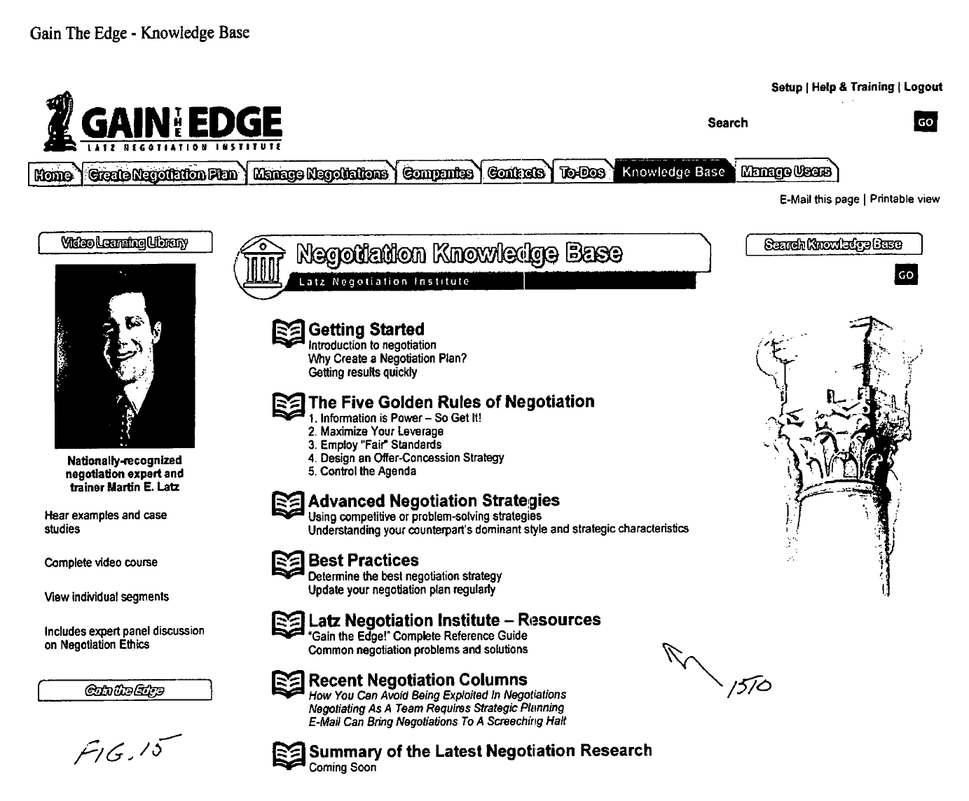

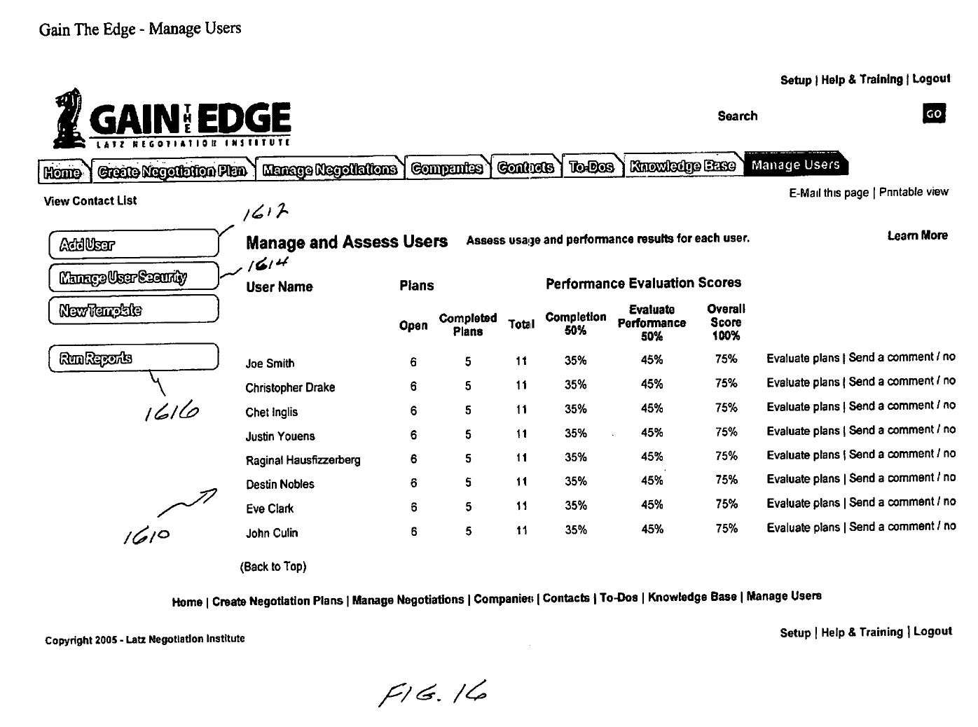

For example, referring to FIG. 16, the strategic negotiation system 100 may generate a user management interface 1610 for managing and assessing users. The user management interface 1610 may include options for various functions, such as adding users 1612, managing user security functions 1614 such as access levels and passwords, and running reports 1616. The user management interface 1610 may also list users and statistics and comments associated with the users, such as data relating to how many negotiations each user is currently handling, how many have been completed for a particular period, statistics on completion rates and success rates, and links for evaluating the negotiation plans used by the various users or sending comments to the users.

The strategic negotiation system 100 may also provide a reporting function. The reporting function may generate one or more reports relating to the various negotiations or other matters. For example, the report function may generate reports listing task lists for a particular negotiation, multiple negotiations, or all negotiations. The report function may also facilitate generation of reports relating to the offer-concession process for one or more negotiations, such as charts illustrating the offers and concessions of one or multiple parties, or reports listing the offer-concession strategies used by a particular party in one negotiation or all negotiations. The report function may generate information in the form of summary reports that may assist the user in any other way.

The strategic negotiation system 100 of the present embodiment is suitably configured to provide, analyze, and store strategic information in any suitable manner and according to any appropriate techniques. In the present embodiment, the strategic negotiation system 100 and the strategic negotiation system program are configured to store strategic negotiation information relating to a negotiation, automatically assess the negotiation information, and provide a strategic negotiation analysis according to the assessment. The strategic negotiation system 100 may further receive strategic information relating to new negotiations, retrieve relevant information from the database, organize and analyze information relating to negotiations, and store relevant information. For example, the strategic negotiation system may receive strategic information regarding one or more negotiations, prompt the user for information relating to the negotiation, capture and organize the information for retrieval, analysis, and presentation, search for additional strategic information that may be relevant to the current negotiation, analyze information for various issues, plans, and strategies, make recommendations based on the analysis, record the progress of the negotiation, and maintain the information database for later use.

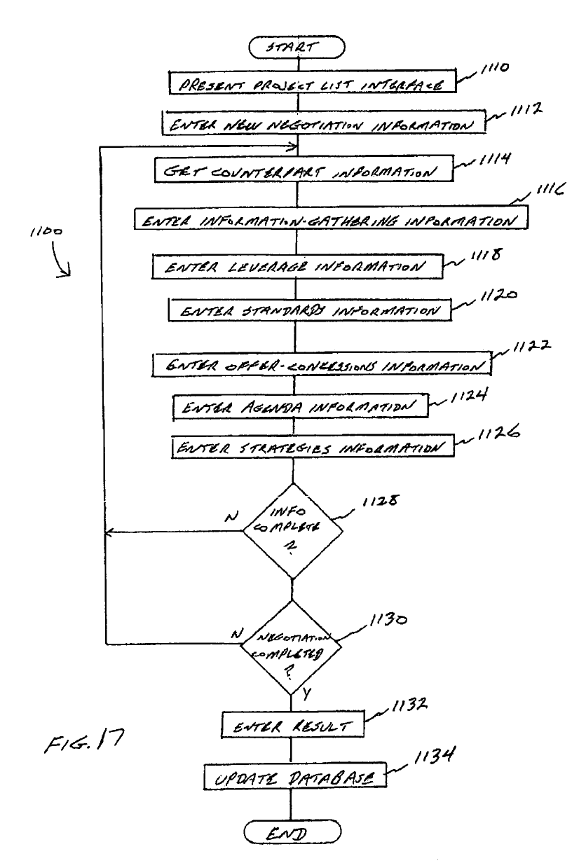

For example, referring to FIG. 17, a negotiation process 1100 according to various aspects of the present invention may begin with initiation of the strategic negotiation program, which initially presents a login interface for establishing access to the strategic negotiation system 100. When the user has logged on and been authorized, the strategic negotiation interface may present the quick start home page including the project list interface 200 (1110). The user then selects to begin a new negotiation, which initiates a new negotiation process. The strategic negotiation system 100 prompts the user for various information, such as the title of the negotiation, a description of the negotiation (1112), and either selects the counterpart information from the database or enters information for a new counterpart (1114). The strategic negotiation system 100 then populates various fields in the various interfaces with the information and stores the information relating to the new negotiation, such as in the database.

Upon entry of such basic information, the user may then enter strategic negotiation details for the various negotiation functions. The user suitably selects each of the links or tabs for the negotiation interfaces in turn and provides as much information as possible (1114, 1116, 1118, 1120, 1122, 1124, 1126). The information is stored and may be used to populate the fields of other interfaces. For example, as various tasks are created using the various negotiation interfaces, the tasks are automatically added to the task list in the general information interface. As the strategic information is entered, the strategic negotiation system analyzes the negotiation information in any suitable manner, such as analyzing the data provided by the user, retrieving and analyzing relevant information from the database, identifying correlations between characteristics of the current negotiation and previous negotiations stored in the database, determining leverage values, and providing strategy recommendations and other feedback to the user. The user may elect to revisit the various interfaces multiple times (1128), for example in view of feedback from the strategic negotiation system, until satisfied that the plans and strategies established and the facts provided are acceptable.

The user may then proceed with the negotiations and execute the items on the task list. As the negotiations proceed and tasks are accomplished, the information in the strategic negotiation system 100 is updated and analyzed. The user may review the ongoing analyses and adjust the negotiation strategy and tasks accordingly. The process of updating the strategic negotiation system 100, storing the information in the database, and adjusting the analyses, strategy, and plan may continue until the negotiation concludes (1130). Upon conclusion of the negotiation, the result of the negotiation may be entered (1132) and the negotiation project may be designated as closed, but the information relating to the negotiation, the counterpart, and any other relevant information is retained in the database for the benefit of future negotiations (1134).

The particular implementations shown and described are illustrative of the invention and its best mode and are not intended to otherwise limit the scope of the present invention in any way. Indeed, for the sake of brevity, conventional processing, data entry, computer systems, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

The present invention has been described above with reference to a particular embodiment. However, changes and modifications may be made to the particular embodiment without departing from the scope of the present invention. These and other changes or modifications are intended to be included within the scope of the present invention.

1. A computer-implemented negotiation system, comprising:
an information system configured to capture negotiation information relating to at least one negotiation; and
an assessment system configured to process the negotiation information and generate guidance information for conducting the negotiation.

2. A computer-implemented negotiation system according to claim 1, wherein:
the information system is configured to capture need information relating to a need for at least one party; and
the assessment system is configured to determine a leverage for at least one party based on the need information.

3. A computer-implemented negotiation system according to claim 2, wherein:
the information system is configured to capture alternatives information relating to available alternatives for at least one party; and
the assessment system is configured to assess the leverage for at least one party based on the alternatives information.

4. A computer-implemented negotiation system according to claim 3, wherein the assessment system is configured to:
assign a need value corresponding to a level of need based on the need information;
assign an alternatives value corresponding to a level of acceptability of an alternative based on the alternatives information; and generate a leverage value based on a sum of the need value and the alternatives value.

5. A computer-implemented negotiation system according to claim 1, wherein the information system is configured to capture information relating to multiple offers and concessions of at least one party associated with multiple negotiations.

6. A computer-implemented negotiation system according to claim 1, wherein:
the information system is configured to capture information relating to a likelihood of a future relationship between at least two parties, a number of issues to be negotiated, a number of zero-sum issues to be negotiated, and a likelihood of an opposing party to use a problem-solving strategy; and
the assessment system is configured to recommend at least one of a problem-solving strategy, a competitive strategy, and a combination of problem-solving and competitive strategies according to the likelihood of the future relationship between the at least two parties, the number of issues to be negotiated, the importance of one or more zero-sum issues to be negotiated, and the likelihood of the opposing party to use a problem-solving strategy.

7. A computer-implemented negotiation system according to claim 1, wherein the negotiation information includes:
goal information relating to a goal of at least one party;
leverage information relating to a leverage of at least one party;
standards information relating to a standard that applies to the at least one negotiation;
offer-concession information relating to an anticipated offer and concession process; and
agenda information relating to controlling an agenda for the at least one negotiation.

8. A computer-implemented negotiation system according to claim 1, wherein the assessment system is configured to organize and present the negotiation information according to a template.

9. A negotiation system embodied in a computer program, comprising:
an information system configured to capture negotiation information relating to at least one negotiation; and
an assessment system configured to process the negotiation information and generate guidance information for conducting the negotiation.

10. A negotiation system according to claim 8, wherein:
the information system is configured to capture need information relating to a need for at least one party; and
the assessment system is configured to determine a leverage for at least one party based on the need information.

11. A negotiation system according to claim 10, wherein:
the information system is configured to capture alternatives information relating to available alternatives for at least one party; and
the assessment system is configured to assess the leverage for at least one party based on the alternatives information.

12. A negotiation system according to claim 11, wherein the assessment system is configured to:
assign a need value corresponding to a level of need based on the need information;
assign an alternatives value corresponding to a level of acceptability of an alternative based on the alternatives information; and
generate a leverage value based on a sum of the need value and the alternatives value.

13. A negotiation system according to claim 8, wherein the information system is configured to capture information relating to multiple offers and concessions of at least one party associated with multiple negotiations.

14. A negotiation system according to claim 8, wherein:
the information system is configured to capture information relating to a likelihood of a future relationship between at least two parties, a number of issues to be negotiated, a number of zero-sum issues to be negotiated, and a likelihood of an opposing party to use a problem-solving strategy; and
the assessment system is configured to recommend at least one of a problem-solving strategy, a competitive strategy, and a combination of problem-solving and competitive strategies according to the likelihood of the future relationship between the at least two parties, the number of issues to be negotiated, the importance of one or more zero-sum issues to be negotiated, and the likelihood of the opposing party to use a problem-solving strategy.

15. A negotiation system according to claim 8, wherein the negotiation information includes:
goal information relating to a goal of at least one party;
leverage information relating to a leverage of at least one party;
standards information relating to a standard that applies to the at least one negotiation;
offer-concession information relating to an anticipated offer and concession process; and
agenda information relating to controlling an agenda for the at least one negotiation.

16. A negotiation system according to claim 8, wherein the assessment system is configured to organize and present the negotiation information according to a template.

17. A computer-implemented method for strategically performing a negotiation, comprising:
acquiring negotiation information relating to a negotiation;
storing the negotiation information in a memory;
processing the negotiation information; and
providing a guidance information according to the processing.

18. A computer-implemented method according to claim 17, wherein:
acquiring negotiation information includes capturing need information relating to a need for at least one party; and
processing the negotiation information includes determining a leverage for at least one party based on the need information.

19. A computer-implemented method according to claim 18, wherein:
acquiring negotiation information includes capturing alternatives information relating to available alternatives for at least one party; and
processing the negotiation information includes assessing the leverage for at least one party based on the alternatives information.

20. A computer-implemented method according to claim 19, wherein processing the negotiation information includes:
assigning a need value corresponding to a level of need based on the need information;
assigning an alternatives value corresponding to a level of acceptability of an alternative based on the alternatives information; and
generating a leverage value based on a sum of the need value and the alternatives value.

21. A computer-implemented method according to claim 17, wherein acquiring negotiation information includes capturing information relating to multiple offers and concessions of at least one party associated with multiple negotiations.

22. A computer-implemented method according to claim 17, wherein:
acquiring negotiation information includes capturing information relating to a likelihood of a future relationship between at least two parties, a number of issues to be negotiated, a number of zero-sum issues to be negotiated, and a likelihood of an opposing party to use a problem-solving strategy; and
providing the guidance information includes recommending at least one of a problem-solving strategy, a competitive strategy, and a combination of problem-solving and competitive strategies according to the likelihood of the future relationship between the at least two parties, the number of issues to be negotiated, the importance of one or more zero-sum issues to be negotiated, and the likelihood of the opposing party to use a problem-solving strategy.

23. A computer-implemented method according to claim 17, wherein the negotiation information includes:
goal information relating to a goal of at least one party;
leverage information relating to a leverage of at least one party;
standards information relating to a standard that applies to the at least one negotiation;
offer-concession information relating to an anticipated offer and concession process; and
agenda information relating to controlling an agenda for the at least one negotiation.

24. A computer-implemented method according to claim 17, wherein providing the guidance information includes organizing and presenting the negotiation information according to a template.
